(19) United States
(12) Patent Application Publication
(10) Pub. No.: US 2023/0298001 A1
(43) Pub. Date: Sep. 21, 2023

(54) NON-FUNGIBLE TOKEN (NFT) PURCHASE AND TRANSFER SYSTEM

(71) Applicant: PAYPAL, INC., San Jose, CA (US)

(72) Inventors: Mehak Jethmalani, Jersey City, NJ (US); Rivka Aspler Yaskil, Hod Hasharon (IL)

(21) Appl. No.: 17/655,670

(22) Filed: Mar. 21, 2022

(51) Int. Cl. G06Q 20/36; G06Q 20/38; G06Q 20/02

(52) U.S. Cl. CPC G06Q 20/36; G06Q 20/389; G06Q 20/02

(57) ABSTRACT

Methods and systems for enabling off-chain transactions via a non-fungible token (NFT) marketplace are provided. A plurality of digital wallets associated with a service provider are provided with access to the NFT marketplace. The NFT marketplace corresponds to a decentralized blockchain associated with an entity that is different from the service provider. A request to perform a transaction involving a purchase, via the NFT marketplace, of an NFT associated with a specified source address is received from a first user of the service provider associated with a first identifier and a first digital wallet. Responsive to determining that the specified source address corresponds to a second user of the service provider associated with a second identifier and a second digital wallet, an identifier associated with the NFT is updated from the second identifier associated with the second user to the first identifier associated with the first user.

### TECHNICAL FIELD

The present disclosure generally relates to blockchain technology, and more specifically, to systems and methods for purchasing and transferring non-fungible tokens between users of a decentralized blockchain.

### BACKGROUND

Blockchains have become a popular computer data structure for storing transaction data due to its inherent peer-to-peer and immutable characteristics. For example, blockchains have been used as a decentralized ledger to record transaction data associated with various cryptocurrencies, smart contracts, and other types of transaction data. Copies and/or parts of a blockchain can be stored across different computer nodes, where each computer node may be configured to validate transactions and add new transaction data to the blockchain. As a new transaction is conducted, one or more of the computer nodes may be configured to validate the new transaction (e.g., through a proof-of-work or a proof-of-stake mechanism, etc.). Once the new transaction is validated, the transaction data of the new transaction may be packaged into a block and appended to the copies of the blockchain by the one or more of the computer nodes.

Some blockchains, such as the Ethereum blockchain, feature smart contract functionality and include a decentralized replicated virtual machine that may execute smart contracts. Smart contracts are programs stored on a blockchain that execute when predetermined conditions are met. Smart contracts may be used to implement different types of tokens on the blockchain for various purposes. Each token type may implement a respective token standard. For example, token standards on the Ethereum blockchain, introduced as Ethereum Requests for Comment (ERC), include, but are not limited to, the ERC-20 standard for fungible tokens, the ERC-721 standard for non-fungible tokens, and the ERC-1155 standard for both fungible and non-fungible tokens. Fungible tokens, such as virtual currencies, are interchangeable and essentially indistinguishable from one another. By contrast, a non-fungible token (NFT) represents a unique, non-interchangeable asset that is entirely digital or a tokenized version of a real-world asset. NFTs can be traded through an NFT marketplace that connects buyers and sellers.

The purchase and sale of NFTs in such a marketplace, however, typically requires a prior understanding and familiarity of how NFTs and the NFT transfer process work. A buyer of an NFT, for instance, would need to know how to connect her digital wallet to the NFT marketplace and configure the wallet to control the private keys needed to access the NFT. As a consequence, first-time or less-experienced users may be discouraged from engaging in transactions involving the purchase or sale of NFTs.

### BRIEF DESCRIPTION OF THE DRAWINGS

The accompanying drawings, which are included to provide further understanding and are incorporated in and constitute a part of this specification, illustrate disclosed embodiments and, together with the description, serve to explain the principles of the disclosed embodiments. In the drawings:

FIG. 1 is a block diagram illustrating an example of a distributed computing system for facilitating one or more blockchain based transactions.

FIG. 2 is a block diagram illustrating an example of a blockchain network.

FIG. 3 is a block diagram illustrating an example of a blockchain.

FIG. 4 is a diagram of an example transaction message.

FIG. 5 is a diagram of an example transaction broadcast the blockchain network.

FIG. 6A is a flow diagram of an example process for performing a blockchain based transaction.

FIG. 6B is a flow diagram of another example process for performing a blockchain based transaction.

FIG. 7 is a flow diagram of a process for facilitating a transaction involving a purchase of a non-fungible token (NFT) by a user of a service provider via an NFT marketplace, according to an embodiment of the present disclosure.

FIG. 8 is a flow diagram of a process for facilitating a group purchase of the NFT involved in the transaction of FIG. 7, according to an embodiment of the present disclosure.

FIG. 9 is a flow diagram of a process for facilitating a second transaction involving a sale of the NFT by a user of the service provider via the NFT marketplace of FIG. 7, according to an embodiment of the present disclosure.

FIG. 10 illustrates an example of a workflow for an NFT marketplace transaction involving the purchase and transfer of an NFT between a buyer and a seller who are different users of a service provider.

FIG. 11 illustrates an example of a workflow for holding and showcasing NFTs purchased by a user of the service provider of FIG. 10.

FIG. 12 illustrates another example of a workflow for an NFT marketplace transaction involving the purchase and transfer of an NFT between a buyer who is a user of the service provider of FIG. 10 and a seller who is a third-party decentralized wallet user.

FIG. 13 illustrates yet another example of a workflow for an NFT marketplace transaction involving the sale and transfer of an NFT between a seller who is a user of the service provider of FIG. 10 and a buyer who is a third-party decentralized wallet user.

FIG. 14 is a block diagram that illustrates an example of a client-server system in which embodiments of the present disclosure may be implemented.

FIG. 15 is a block diagram that illustrates an example of a computing device in which embodiments of the present disclosure may be implemented.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

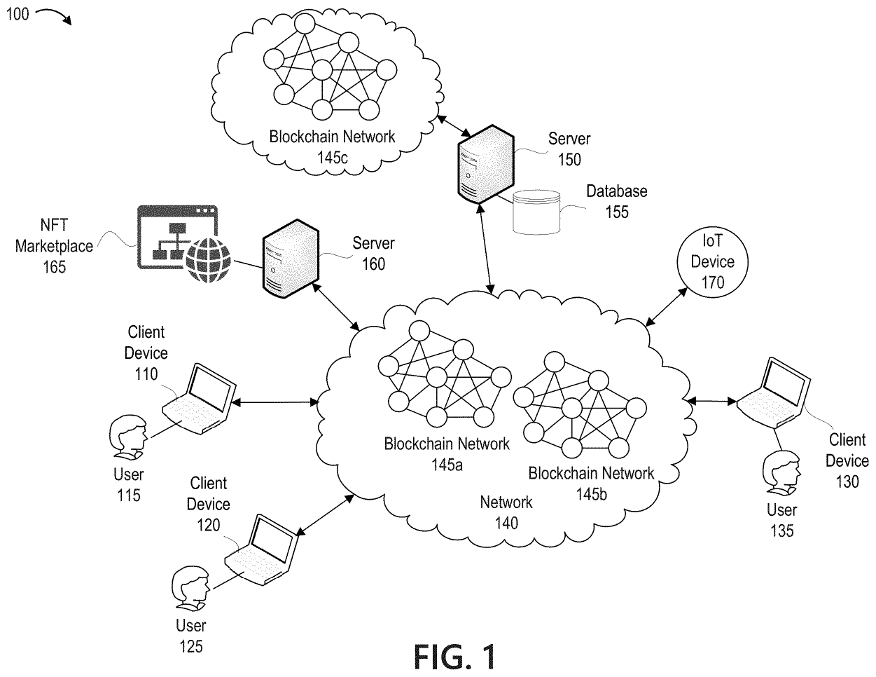

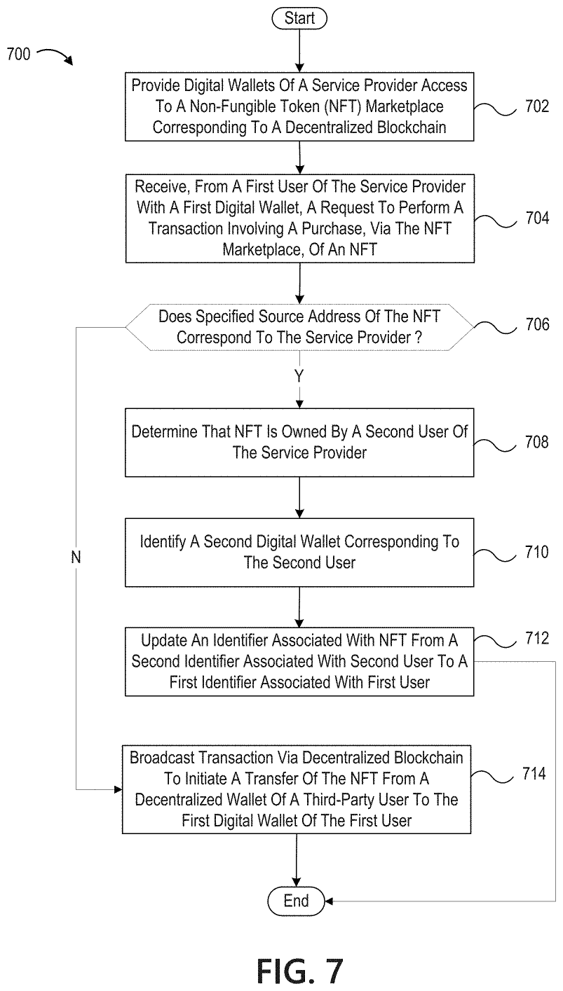

FIGS. 1-5, 6A, 6B, 14, and 15 describe certain aspects of blockchain operations, according to some embodiments of the present disclosure. FIGS. 7-13 describe certain other aspects relating to the purchase and transfer of non-fungible tokens (NFTs) by users of a service provider, according to some embodiments. As will be described in further detail below, the service provider may provide a plurality of digital wallets for users of the service provider to access to a non-fungible token (NFT) marketplace that corresponds to a decentralized blockchain associated with an entity that is different from the service provider. It should be appreciated that an NFT in accordance with the various embodiments of the present disclosure may be implemented according to any of various token standards. For example, an NFT may be implemented according to the ERC-20 standard, the ERC-721 standard, the ERC-994 standard, the ERC-998 standard, the ERC-1155 standard, and/or any other token standard configured for the Ethereum blockchain network or any other blockchain network that includes a virtual machine for executing contract bytecode on its blockchain as would be apparent to one of skill in the art in possession of the present disclosure. Each token standard may have different requirements of features that a token must have to be considered a token that implements that standard and that can be used by smart contracts or applications that also are generated according to that token standard.

In some implementations, the NFTs and smart contracts that implement various token standards may be tag-based and derived by Application Programming Interfaces (APIs). Thus, composability of these token standards occurs with an API. Composability means that the token has the ability to combine parts or elements. For example, if a first smart contract generates a token that implements the ERC-20 standard, that first smart contract may be used by other smart contracts or that first smart contract may interface with existing smart contracts on the blockchain to use or interact with the existing smart contracts from within the first smart contract utilizing APIs.

In its broadest sense, blockchain refers to a framework that supports a trusted ledger that is stored, maintained, and updated in a distributed manner in a peer-to-peer network. For example, in a cryptocurrency application, such as Bitcoin or Ethereum, Ripple, Dash, Litecoin, Dogecoin, zCash, Tether, Bitcoin Cash, Cardano, Stellar, EOS, NEO, NEM, Bitshares, Decred, Augur, Komodo, PIVX, Waves, Steem, Monero, Golem, Stratis, Bytecoin, Ardor, or in digital currency exchanges, such as Coinbase, Kraken, CEX.IO, Shapeshift, Poloniex, Bitstamp, Coinmama, Bisq, LocalBitcoins, Gemini and others where the distributed ledger represents each transaction and where units of the cryptocurrency are transferred between entities. For example, using a digital currency exchange, a user may buy any value of digital currency or exchange any holdings in digital currencies into worldwide currency or other digital currencies. Each transaction can be verified by the distributed ledger and only verified transactions are added to the ledger. (Note that other digital asset transfers are enabled by other blockchain schemes as well; cryptocurrency examples are used variously herein for ease of illustration and understanding.) The ledger, along with many aspects of blockchain, may be referred to as “decentralized” in that a central authority is typically not present. Because of this, the accuracy and integrity of the ledger cannot be attacked at a single, central location. Modifying the ledger at all, or a majority of, locations where it is stored is made difficult so as to protect the integrity of the ledger. This is due in large part because individuals associated with the nodes that make up the peer-to-peer network have a vested interest in the accuracy of the ledger. Many uses of blockchain distributed ledgers other than cryptocurrency are possible, of course, as further discussed below.

Though maintaining cryptocurrency transactions in the distributed ledger may be the most recognizable use of blockchain technology today, the ledger may be used in a variety of different fields. Indeed, blockchain technology is applicable to any application where data of any type may be accessed where the accuracy of the data is assured. For example, a supply chain may be maintained in a blockchain ledger, where the transfer of each component from party to party, and location to location, may be recorded in the ledger for later retrieval. Doing so allows for easier identification of a source for a defective part and where other such defective parts have been delivered. Similarly, food items may be tracked in like manner from farm to grocery store to purchaser. Other data as well as other digital assets may be maintained, recorded, and/or transferred according to various blockchain schemes.

Implementations of the present disclosure will now be described in detail with reference to the accompanying figures.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

Computing Architecture

As discussed above, the distributed ledger in a blockchain framework is stored, maintained, and updated in a peer-to-peer network. In one example, the distributed ledger maintains a number of blockchain transactions. FIG. 1 shows an example of a distributed computing system 100 for facilitating blockchain based transactions. As will be described in further detail below, such transactions may include transactions involving the purchase and transfer of a non-fungible token (NFT) via an NFT marketplace. As shown in the example of FIG. 1, system 100 includes a client device 110 of a user 115, a client device 120 of a user 125, a client device 130 of a user 135, a server 150, a server 160, and an Internet of Things (IoT) device 170 interconnected via a network 140. Each of client devices 110, 120, and 130 may be any of various computing devices including at least one processor and a memory. Examples of such a computing device include, but are not limited to, a mobile phone, a tablet computer, a laptop computer, a desktop computer, or a workstation. Each of servers 150 and 160 may be any of various types of computer servers, e.g., a cluster of computers in a server farm, capable of serving data to other computing devices, including client devices 110, 120, and 130, via network 140. The network 140 may be any of a variety of available networks, such as the Internet, and represents a worldwide collection of networks and gateways to support communications between devices connected to the network 140. The IoT device 170 may be any of various devices with connectivity hardware to connect and exchange data with other IoT devices. Examples of such IoT devices include, but are not limited to, vehicles, home appliances, embedded electronics, software, sensors, actuators, thermostats, light bulbs, door locks, refrigerators, RFID implants, RFID tags, pacemakers, wearable devices, smart home devices, cameras, trackers, pumps, POS devices, and stationary and mobile communication devices.

In one or more embodiments, system 100 may also include one or more distributed or peer-to-peer (P2P) networks, such as blockchain networks 145a-c (collectively referred to as blockchain networks 145). As shown in FIG. 1, blockchain networks 145a and 145b may be public blockchain networks included within network 140. Blockchain network 145c may be, for example, a separate private blockchain network connected to server 150. The private blockchain network and server 150 in this example may be associated with a service provider. As will be described in further detail below, the service provider may use server 150 to facilitate various blockchain based transactions for users of the service provider, e.g., users 115 and 125 of client devices 110 and 120, respectively. By contrast, user 135 of client device 130 may be, for example, a third-party user associated with a decentralized digital wallet.

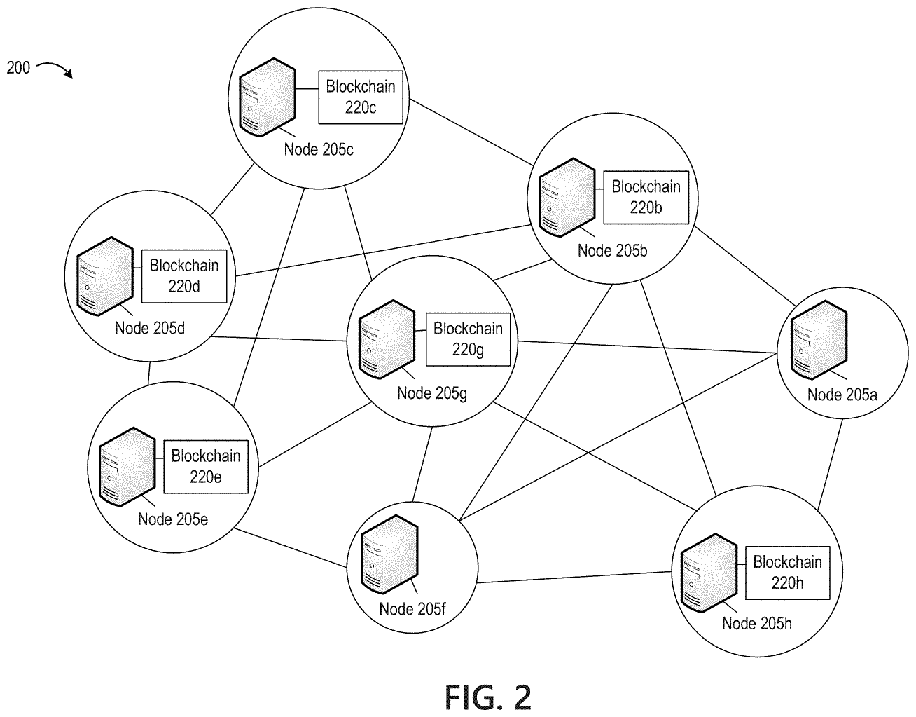

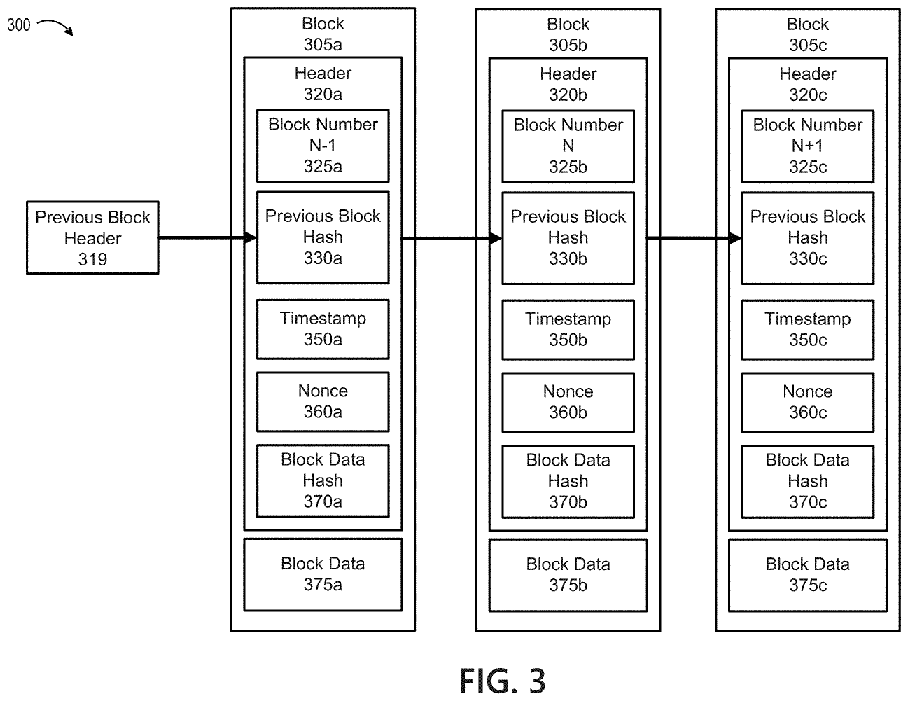

In one example, a blockchain based transaction may involve a transfer of data or value between different entities or users, such as the first user 115 of the first client device 110 and the second user 125 of the second client device 120 in FIG. 1. The server 150 may include one or more applications, for example, a transaction application configured to facilitate the transaction between the entities by utilizing a blockchain associated with one of the blockchain networks 145. As an example, the first user 115 may request or initiate a transaction with the second user 125 via a user application executing on the first client device 110. The transaction may be related to a transfer of value or data from the first user 115 to the second user 125. The first client device 110 may send a request of the transaction to the server 150. The server 150 may send the requested transaction to one of the blockchain networks 145 to be validated and approved, as will be discussed further below. Each blockchain network 145 in this example may comprise a plurality of interconnected devices (or nodes), as will be described in more detail with reference to FIG. 2. As discussed above, a ledger or blockchain, is a distributed database for maintaining a growing list of records comprising any type of information. A blockchain, as described in more detail with reference to FIG. 3, may be stored at least at multiple nodes (or devices) of the one or more blockchain networks 145.

In another example, a blockchain based transaction may involve the purchase or sale of an NFT via an NFT marketplace 165. The NFT marketplace 165 may be associated with, for example, a third-party broker or other entity that is different from the service provider described above. NFT marketplace 165 may be a decentralized application or blockchain-integrated e-commerce website hosted at server 160, which provides an online marketplace for buyers and sellers to purchase and sell NFTs via a corresponding decentralized blockchain. In one or more embodiments, users 115, 125, and 135 may access NFT marketplace 165 over network 140 via a web browser executable at their respective client devices 110, 120, and 130. Client devices 110, 120, and 130 may also execute a digital wallet application (or simply, “digital wallet”) associated with each user. In some implementations, the digital wallet application may be a browser extension associated with the web browser executable at each client device. Alternatively, the digital wallet application may be implemented as a standalone application executable at the respective client devices. In one or more embodiments, the digital wallet application at each client device may be used to establish a connection over network 140 between the client device and NFT marketplace 165, e.g., for purposes of exchanging secure communications related to blockchain based transactions involving the purchase or sale of NFTs via NFT marketplace 165.

In some embodiments, digital wallets associated with the service provider may be provided with access to NFT marketplace 165 via, for example, an application programming interface (API) connection of the service provider. Such digital wallets may correspond to different users of the service provider. In some implementations, the information associated with users of the service provider and their corresponding digital wallets may be stored in a database 155 coupled to server 150. Database 155 may be any type of data store used to store various kinds of data. The information stored in database 155 may be accessed by server 150 to facilitate transactions involving the purchase or sale of an NFT, as initiated by a user of the service provider, as will be described in further detail below with respect to FIGS. 7-13.

Blockchain Network

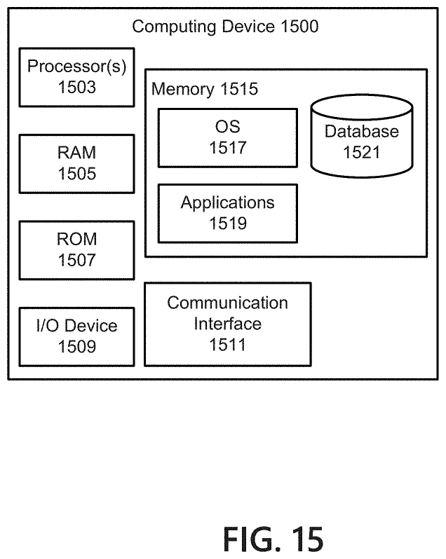

FIG. 2 shows an example blockchain network 200 comprising a plurality of interconnected nodes or devices 205a-h (generally referred to as nodes 205). Each of the nodes 205 may comprise a computing device, such as computing device 1500 of FIG. 15, as will be described below. Although FIG. 2 shows a single device, each of the nodes 205 may comprise a plurality of devices (e.g., a pool). The blockchain network 200 may be associated with a blockchain 220. Some or all of the nodes 205 may replicate and save an identical copy of the blockchain 220. For example, FIG. 3 shows that the nodes 205b-e and 205g-h store copies of the blockchain 220. The nodes 205b-e and 205g-h may independently update their respective copies of the blockchain 220 as discussed below.

Blockchain Node Types

Blockchain nodes, for example, the nodes 205, may be full nodes or lightweight nodes. Full nodes, such as the nodes 205b-e and 205g-h, may act as a server in the blockchain network 200 by storing a copy of the entire blockchain 220 and ensuring that transactions posted to the blockchain 220 are valid. The full nodes 205b-e and 205g-h may publish new blocks on the blockchain 220. Lightweight nodes, such as the nodes 205a and 205f, may have fewer computing resources than full nodes. For example, IoT devices often act as lightweight nodes. The lightweight nodes may communicate with other nodes 205, provide the full nodes 205b-e and 205g-h with information, and query the status of a block of the blockchain 220 stored by the full nodes 205b-e and 205g-h. In this example, however, as shown in FIG. 2, the lightweight nodes 205a and 205f may not store a copy of the blockchain 220 and thus, may not publish new blocks on the blockchain 220.

Blockchain Network Types

The blockchain network 200 and its associated blockchain 220 may be public (permissionless), federated or consortium, or private. If the blockchain network 200 is public, then any entity may read and write to the associated blockchain 220. However, the blockchain network 200 and its associated blockchain 220 may be federated or consortium if controlled by a single entity or organization. Further, any of the nodes 205 with access to the Internet may be restricted from participating in the verification of transactions on the blockchain 220. The blockchain network 200 and its associated blockchain 220 may be private (permissioned) if access to the blockchain network 200 and the blockchain 220 is restricted to specific authorized entities, for example organizations or groups of individuals. Moreover, read permissions for the blockchain 220 may be public or restricted while write permissions may be restricted to a controlling or authorized entity.

Blockchain

As discussed above, a blockchain 220 may be associated with a blockchain network 200. FIG. 3 shows an example blockchain 300. The blockchain 300 may comprise a plurality of blocks 305a, 305b, and 305c (generally referred to as blocks 305). The blockchain 300 comprises a first block (not shown), sometimes referred to as the genesis block. Each of the blocks 305 may comprise a record of one or a plurality of submitted and validated transactions. The blocks 305 of the blockchain 300 may be linked together and cryptographically secured. In some cases, the post-quantum cryptographic algorithms that dynamically vary over time may be utilized to mitigate ability of quantum computing to break present cryptographic schemes. Examples of the various types of data fields stored in a blockchain block are provided below. A copy of the blockchain 300 may be stored locally, in the cloud, on grid, for example by the nodes 205b-e and 205g-h, as a file or in a database.

Blocks

Each of the blocks 305 may comprise one or more data fields. The organization of the blocks 305 within the blockchain 300 and the corresponding data fields may be implementation specific. As an example, the blocks 305 may comprise a respective header 320a, 320b, and 320c (generally referred to as headers 320) and block data 375a, 375b, and 375c (generally referred to as block data 375). The headers 320 may comprise metadata associated with their respective blocks 305. For example, the headers 320 may comprise a respective block number 325a, 325b, and 325c. As shown in FIG. 3, the block number 325a of the block 305a is N−1, the block number 325b of the block 305b is N, and the block number 325c of the block 305c is N+1. The headers 320 of the blocks 305 may include a data field comprising a block size (not shown).

The blocks 305 may be linked together and cryptographically secured. For example, the header 320b of the block N (block 305b) includes a data field (previous block hash 330b) comprising a hash representation of the previous block N−1's header 320a. The hashing algorithm utilized for generating the hash representation may be, for example, a secure hashing algorithm 256 (SHA-256) which results in an output of a fixed length. In this example, the hashing algorithm is a one-way hash function, where it is computationally difficult to determine the input to the hash function based on the output of the hash function. Additionally, the header 320c of the block N+1 (block 305c) includes a data field (previous block hash 330c) comprising a hash representation of block N's (block 305b) header 320b.

The headers 320 of the blocks 305 may also include data fields comprising a hash representation of the block data, such as the block data hash 370a-c. The block data hash 370a-c may be generated, for example, by a Merkle tree and by storing the hash or by using a hash that is based on all of the block data. The headers 320 of the blocks 305 may comprise a respective nonce 360a, 360b, and 360c. In some implementations, the value of the nonce 360a-c is an arbitrary string that is concatenated with (or appended to) the hash of the block. The headers 320 may comprise other data, such as a difficulty target.

The blocks 305 may comprise a respective block data 375a, 375b, and 375c (generally referred to as block data 375). The block data 375 may comprise a record of validated transactions that have also been integrated into the blockchain network 200 via a consensus model (described below). As discussed above, the block data 375 may include a variety of different types of data in addition to validated transactions. Block data 375 may include any data, such as text, audio, video, image, or file, that may be represented digitally and stored electronically.

Blockchain Transaction

In one example, a blockchain based transaction may generally involve a transfer of data or value or an interaction between entities and described in more detail below. Referring back to FIG. 1, each of servers 150 and 160 may include one or more applications, for example, a transaction application configured to facilitate a blockchain transaction between entities. The entities may include users, devices, etc. The first user 115 may request or initiate a transaction with the second user 125 via a user application executing on the first client device 110. The transaction may be related to a transfer of value or data from the first user 115 to the second user 125. The value or data may represent money, a contract, property, records, rights, status, supply, demand, alarm, trigger, or any other asset that may be represented in digital form. The transaction may represent an interaction between the first user 115 and the second user 125.

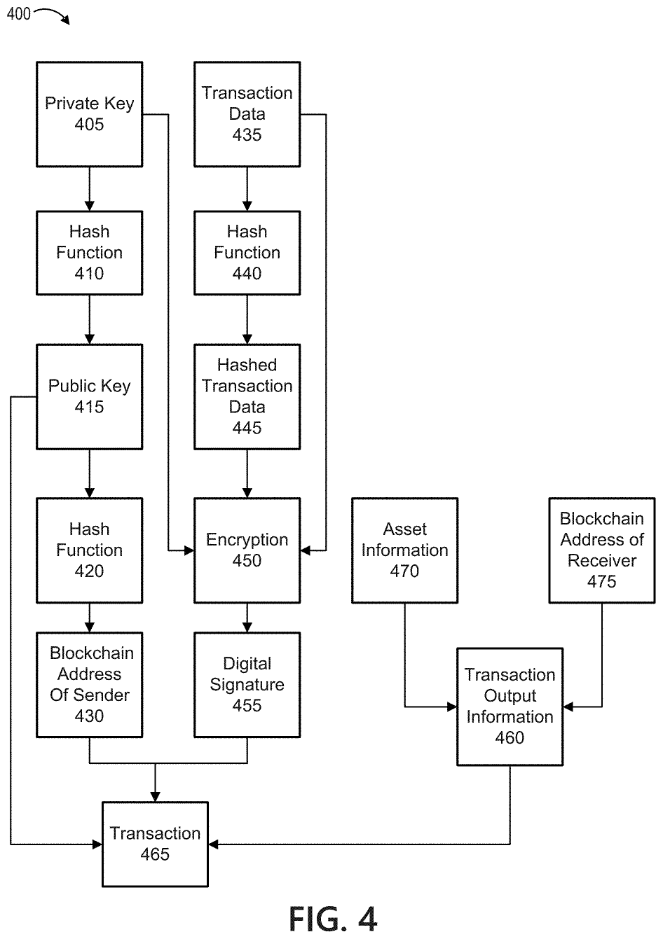

FIG. 4 is a diagram of a transaction 465 generated by the transaction application. The transaction 465 may include a public key 415, a blockchain address 430 associated with the first user 115, a digital signature 455, and transaction output information 460. The transaction application may derive a public key 415 from a private key 405 of the first user 115 by applying a cryptographic hash function 410 to the private key 405. The cryptographic hash function 410 may be based on AES, SHA-2, SHA-3, RSA, ECDSA, ECDH (elliptic curve cryptography), or DSA (finite field cryptography), although other cryptographic models may be utilized. More information about cryptographic algorithms may be found in Federal Information Processing Standards Publication (FIPS PUB 180-3), Secure Hash Standard. The transaction application may derive an address or identifier for the first user 115, such as the blockchain address 430, by applying a hash function 420 to the public key 415. Briefly, a hash function is a function that may be used for mapping arbitrary size data to fixed size data. The value may also be referred to as a digest, a hash value, a hash code, or a hash. In order to indicate that the first user 115 is the originator of the transaction 465, the transaction application may generate the digital signature 455 for the transaction data 435 using the private key 405 of the first user 115. The transaction data 435 may include information about the assets to be transferred and a reference to the sources of the assets, such as previous transactions in which the assets were transferred to the first user 115 or an identification of events that originated the assets. Generating the digital signature 455 may include applying a hash function 440 to the transaction data 435 resulting in hashed transaction data 445. The hashed transaction data 445 and the transaction data 435 may be encrypted (via an encryption function 450) using the private key 405 of the first user 115 resulting in the digital signature 455. The transaction output information 460 may include asset information 470 and an address or identifier for the second user, such as the blockchain address 475. The transaction 465 may be sent from the first client device 110 to the server 150.

The specific type of cryptographic algorithm being utilized may vary dynamically based on various factors, such as a length of time, privacy concerns, etc. For example, the type of cryptographic algorithm being utilized may be changed yearly, weekly, daily, etc. The type of algorithms may also change based on varying levels of privacy. For example, an owner of content may implement a higher level of protection or privacy by utilizing a stronger algorithm.

Blockchain Addresses

A blockchain network may utilize blockchain addresses to indicate an entity using the blockchain or start and end points in the transaction. For example, a blockchain address for the first user 115, shown in FIG. 4 as the blockchain address 430 of sender, may include an alphanumeric string of characters derived from the public key 415 of the first user 115 based on applying a cryptographic hash function 420 to the public key 415. The methods used for deriving the addresses may vary and may be specific to the implementation of the blockchain network. In some examples, a blockchain address may be converted into a QR code representation, barcode, token, or other visual representations or graphical depictions to enable the address to be optically scanned by a mobile device, wearables, sensors, cameras, etc. In addition to an address or QR code, there are many ways of identifying individuals, objects, etc. represented in a blockchain. For example, an individual may be identified through biometric information such as a fingerprint, retinal scan, voice, facial id, temperature, heart rate, gestures/movements unique to a person etc., and through other types of identification information such as account numbers, home address, social security number, formal name, etc.

Broadcasting Transaction

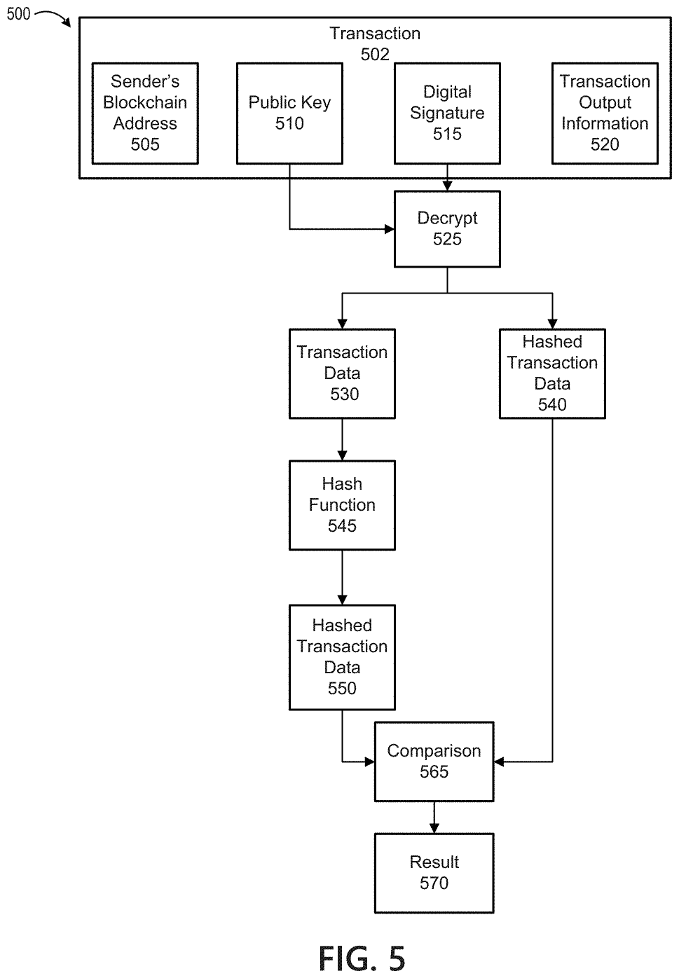

The server 150 may receive transactions from users of the blockchain network 145. The transactions may be submitted to the server 150 via desktop applications, smartphone applications, digital wallet applications, web services, or other software applications. The server 150 may send or broadcast the transactions to the blockchain network 145. FIG. 5 shows an example transaction 502 broadcast by the server 150 to the blockchain network 145. The transaction 502 may be broadcast to multiple nodes 205 of the blockchain network 145. Typically, once the transaction 502 is broadcast or submitted to the blockchain network 145, it may be received by one or more of the nodes 205. Once the transaction 502 is received by the one or more nodes 205 of the blockchain network 145, it may be propagated by the receiving nodes 205 to other nodes 205 of the blockchain network 145.

A blockchain network may operate according to a set of rules. The rules may specify conditions under which a node may accept a transaction, a type of transaction that a node may accept, a type of compensation that a node receives for accepting and processing a transaction, etc. For example, a node may accept a transaction based on a transaction history, reputation, computational resources, relationships with service providers, etc. The rules may specify conditions for broadcasting a transaction to a node. For example, a transaction may be broadcast to one or more specific nodes based on criteria related to the node's geography, history, reputation, market conditions, docket/delay, technology platform. The rules may be dynamically modified or updated (e.g., turned on or off) to address issues such as latency, scalability and security conditions. A transaction may be broadcast to a subset of nodes as a form of compensation to entities associated with those nodes (e.g., through receipt of compensation for adding a block of one or more transactions to a blockchain).

Transaction Validation—User Authentication and Transaction Data Integrity

Not all the full nodes 205 may receive the broadcasted transaction 502 at the same time, due to issues such as latency. Additionally, not all of the full nodes 205 that receive the broadcasted transaction 502 may choose to validate the transaction 502. A node 205 may choose to validate specific transactions, for example, based on transaction fees associated with the transaction 502. The transaction 502 may include a blockchain address 505 for the sender, a public key 510, a digital signature 515, and transaction output information 520. The node 205 may verify whether the transaction 502 is legal or conforms to a pre-defined set of rules. The node 205 may also validate the transaction 502 based on establishing user authenticity and transaction data integrity. User authenticity may be established by determining whether the sender indicated by the transaction 502 is in fact the actual originator of the transaction 502. User authenticity may be proven via cryptography, for example, asymmetric-key cryptography using a pair of keys, such as a public key and a private key. Additional factors may be considered when establishing user authenticity, such as user reputation, market conditions, history, transaction speed, etc. Data integrity of the transaction 502 may be established by determining whether the data associated with the transaction 502 was modified in any way. Referring back to FIG. 4, when the transaction application creates the transaction 465, it may indicate that the first user 115 is the originator of the transaction 465 by including the digital signature 455.

The node 205 may decrypt the digital signature 515 using the public key 510. A result of the decryption may include hashed transaction data 540 and transaction data 530. The node 205 may generate hashed transaction data 550 based on applying a hash function 545 to the transaction data 530. The node 205 may perform a comparison 565 between the first hashed transaction data 540 and the second hashed transaction data 550. If the result 570 of the comparison 565 indicates a match, then the data integrity of the transaction 502 may be established and node 205 may indicate that the transaction 502 has been successfully validated. Otherwise, the data of the transaction 502 may have been modified in some manner and the node 205 may indicate that the transaction 502 has not been successfully validated.

Each full node 205 may build its own block and add validated transactions to that block. Thus, the blocks of different full nodes 205 may comprise different validated transactions. As an example, a full node 205f may create a first block comprising transactions “A,” “B,” and “C.” Another full node 205b may create a second block comprising transactions “C,” “D,” and “E.” Both blocks may include valid transactions. However, only one block may get added to the blockchain, otherwise the transactions that the blocks may have in common, such as transaction “C” may be recorded twice leading to issues such as double-spending when a transaction is executed twice. One problem that may be seen with the above example is that transactions “C,” “D,” and “E” may be overly delayed in being added to the blockchain. This may be addressed a number of different ways as discussed below.

Securing Keys

Private keys, public keys, and addresses may be managed and secured using software, such as a digital wallet. Private keys may also be stored and secured using hardware. The digital wallet may also enable the user to conduct transactions and manage the balance. The digital wallet may be stored or maintained online or offline, and in software or hardware or both hardware and software. Without the public/private keys, a user has no way to prove ownership of assets. Additionally, anyone with access a user's public/private keys may access the user's assets. While the assets may be recorded on the blockchain, the user may not be able to access them without the private key.

Establishing User Identity

While a digital signature may provide a link between a transaction and an owner of assets being transferred, it may not provide a link to the real identity of the owner. In some cases, the real identity of the owner of the public key corresponding to the digital signature may need to be established. The real identity of an owner of a public key may be verified, for example, based on biometric data, passwords, personal information, etc. Biometric data may comprise any physically identifying information such as fingerprints, face and eye images, voice sample, DNA, human movement, gestures, gait, expressions, heart rate characteristics, temperature, etc.

Publishing and Validating a Block

As discussed above, full nodes 205 may each build their own blocks that include different transactions. A node may build a block by adding validated transactions to the block until the block reaches a certain size that may be specified by the blockchain rules. However, only one of the blocks may be added to the blockchain. The block to be added to the blockchain and the ordering of the blocks may be determined based on a consensus model. In a proof of work model, both nodes may compete to add their respective block to the blockchain by solving a complex mathematical puzzle. For example, such a puzzle may include determining a nonce, as discussed above, such that a hash (using a predetermined hashing algorithm) of the block to be added to the blockchain (including the nonce) has a value that meets a range limitation. If both nodes solve the puzzle at the same time, then a “fork” may be created. When a full node 205 solves the puzzle, it may publish its block to be validated by the validation nodes 205 of the blockchain network 145.

In a proof of work consensus model, a node validates a transaction, for example, by running a check or search through the current ledger stored in the blockchain. The node will create a new block for the blockchain that will include the data for one or more validated transactions (see, e.g., block data 375 of FIG. 3). In a blockchain implementation such as Bitcoin, the size of a block is constrained. Referring back to FIG. 3, in this example, the block will include a Previous Block Hash 330 representing a hash of what is currently the last block in the blockchain. The block may also include a hash 370 of its own transaction data (e.g., a so-called Merkle hash). According to a particular algorithm, all or selected data from the block may be hashed to create a final hash value. According to an embodiment of the proof of work model, the node will seek to modify the data of the block so that the final hash value is less than a preset value. This is achieved through addition of a data value referred to as a nonce 360. Because final hash values cannot be predicted based on its input, it is not possible to estimate an appropriate value for the nonce 360 that will result in a final hash value that is less than the pre-set value. Accordingly, in this embodiment, a computationally-intensive operation is needed at the node to determine an appropriate nonce value through a “brute force” trial-and-error method. Once a successful nonce value is determined, the completed block is published to the blockchain network for validation. If validated by a majority of the nodes in the block chain network, the completed block is added to the blockchain at each participating node. When a node's block is not added to the blockchain, the block is discarded and the node proceeds to build a new block. The transactions that were in the discarded block may be returned to a queue and wait to be added to a next block. When a transaction is discarded or returned to the queue, the assets associated with the discarded transaction are not lost, since a record of the assets will exist in the blockchain. However, when a transaction is returned to the queue the return causes a delay in completing the transaction. Reducing the time to complete a transaction may be important. A set of blockchain rules, or renumeration/compensation for a node to process the returned transaction may determine how a returned transaction is to be treated going forward. When a transaction is put into a pool then it can have a priority level but then a rule may indicate that the transaction priority level must exceed a threshold level. The priority level of a returned or discarded transaction may be increased. Another way to reduce the time to complete a transaction is to have the system, service provider, participant in the transaction, or merchant pay additional incentive for nodes to process a returned transaction. As an example, a service provider may identify a network of preferred miners based on geography or based on a volume discount perspective. The time to complete a transaction may be optimized by routing a returned transaction to specific preferred nodes. A transaction may be associated with an address that limits which of the preferred nodes will get to process the transaction if it is returned due to its inclusion in a discarded block. A value may be associated with the transaction so that it goes to preferred miners in a specific geographic location. Additionally, returned transactions may be processed based on pre-set rules. For example, a rule may indicate a commitment to process a specific number of returned transactions to receive additional incentive or compensation.

Blockchain Confirmations

After a block comprising a transaction is added to a blockchain, a blockchain confirmation may be generated for the transaction. The blockchain confirmation may be a number of blocks added to the blockchain after the block that includes the transaction. For example, when a transaction is broadcast to the blockchain, there will be no blockchain confirmations associated with the transaction. If the transaction is not validated, then the block comprising the transaction will not be added to the blockchain and the transaction will continue to have no blockchain confirmations associated with it. However, if a block comprising the transaction is validated, then each of the transactions in the block will have a blockchain confirmation associated with the transaction. Thus, a transaction in a block will have one blockchain confirmation associated with it when the block is validated. When the block is added to the blockchain, each of the transactions in the block will have two blockchain confirmations associated with it. As additional validated blocks are added to the blockchain, the number of blockchain confirmations associated with the block will increase. Thus, the number of blockchain confirmations associated with a transaction may indicate a difficulty of overwriting or reversing the transaction. A higher valued transaction may require a larger number of blockchain confirmations before the transaction is executed.

Consensus Models

As discussed above, a blockchain network may determine which of the full nodes 205 publishes a next block to the blockchain. In a permissionless blockchain network, the nodes 205 may compete to determine which one publishes the next block. A node 205 may be selected to publish its block as the next block in the blockchain based on consensus model. For example, the selected or winning node 205 may receive a reward, such as a transaction fee, for publishing its block, for example. Various consensus models may be used, for example, a proof of work model, a proof of stake model, a delegated proof of stake model, a round robin model, proof of authority or proof of identity model, and proof of elapsed time model.

In a proof of work model, a node may publish the next block by being the first to solve a computationally intensive mathematical problem (e.g, the mathematical puzzle described above). The solution serves as “proof” that the node expended an appropriate amount of effort in order to publish the block. The solution may be validated by the full nodes before the block is accepted. The proof of work model, however, may be vulnerable to a 51% attack described below. The proof of stake model is generally less computationally intensive that the proof of work model. Unlike the proof of work model which is open to any node having the computational resources for solving the mathematical problem, the proof of stake model is open to any node that has a stake in the system. The stake may be an amount of cryptocurrency that the blockchain network node (user) may have invested into the system. The likelihood of a node publishing the next block may be proportional to its stake. Since this model utilizes fewer resources, the blockchain may forego a reward as incentive for publishing the next block. The round robin model is generally used by permissioned blockchain networks. Using this model, nodes may take turns to publish new blocks. In the proof of elapsed time model, each publishing node requests a wait time from a secure hardware within their computer system. The publishing node may become idle for the duration of the wait time and then creates and publishes a block to the blockchain network. As an example, in cases where there is a need for speed and/or scalability (e.g. in the context of a corporate environment), a hybrid blockchain network may switch to be between completely or partially permissioned and permissionless. The network may switch based on various factors, such as latency, security, market conditions, etc.

Forks

As discussed above, consensus models may be utilized for determining an order of events on a blockchain, such as which node gets to add the next block and which node's transaction gets verified first. When there is a conflict related to the ordering of events, the result may be a fork in the blockchain. A fork may cause two versions of the blockchain to exist simultaneously. Consensus methods generally resolve conflicts related to the ordering of events and thus, prevent forks from occurring. In some cases, a fork may be unavoidable. For example, with a proof of work consensus model, only one of the nodes competing to solve a puzzle may win by solving its puzzle first. The winning node's block is then validated by the network. If the winning node's block is successfully validated by the network, then it will be the next block added to the blockchain. However, it may be the case that two nodes may end up solving their respective puzzles at the same time. In such a scenario, the blocks of both winning nodes may be broadcast to the network. Since different nodes may receive notifications of a different winning node, the nodes that receive notification of the first node as the winning node may add the first node's block to their copy of the blockchain. Nodes that receive notification of the second node as the winning node may add the second node's block to their copy of the blockchain. This results in two versions of the blockchain or a fork. This type of fork may be resolved by the longest chain rule of the proof of work consensus model. According to the longest chain rule, if two versions of the blockchain exist, then the network the chain with a larger number of blocks may be considered to be the valid blockchain. The other version of the blockchain may be considered as invalid and discarded or orphaned. Since the blocks created by different nodes may include different transactions, a fork may result in a transaction being included in one version of the blockchain and not the other. The transactions that are in a block of a discarded blockchain may be returned to a queue and wait to be added to a next block.

In some cases, forks may result from changes related to the blockchain implementation, for example, changes to the blockchain protocols and/or software. Forks may be more disruptive for permissionless and globally distributed blockchain networks than for private blockchain networks due to their impact on a larger number of users. A change or update to the blockchain implementation that is backwards compatible may result in a soft fork. When there is a soft fork, some nodes may execute the update blockchain implementation while other nodes may not. However, nodes that do not update to the new blockchain implementation may continue to transact with updated nodes.

A change to the blockchain implementation that is not backwards compatible may result in a hard fork. While hard forks are generally intentional, they may also be caused by unintentional software bugs/errors. In such a case, all publishing nodes in the network may need to update to the new blockchain implementation. While publishing nodes that do not update to the new blockchain implementation may continue to publish blocks according to the previous blockchain implementation, these publishing nodes may reject blocks created based on the new blockchain implementation and continue to accept blocks created based on the previous blockchain implementation. Therefore, nodes on different hard fork versions of the blockchain may not be able to interact with one another. If all nodes move to the new blockchain implementation, then the previous version may be discarded or abandoned. However, it may not be practical or feasible to update all nodes in the network to a new blockchain implementation, for example, if the update invalidates specialized hardware utilized by some nodes.

Blockchain Based Application: Cryptocurrency

Cryptocurrency is a medium of exchange that may be created and stored electronically in a blockchain, such as a the blockchain 145a in FIG. 1. Bitcoin is one example of cryptocurrency, however there are several other cryptocurrencies. Various encryption techniques may be used for creating the units of cryptocurrency and verifying transactions. As an example, the first user 115 may own 10 units of a cryptocurrency. The blockchain 145a may include a record indicating that the first user 115 owns the 10 units of cryptocurrency. The first user 115 may initiate a transfer of the 10 units of cryptocurrency to the second user 125 via a wallet application executing on the first client device 110. The wallet application may store and manage a private key of the first user 115. Examples of the wallet device include a personal computer, a laptop computer, a smartphone, a personal data assistant (PDA), etc.

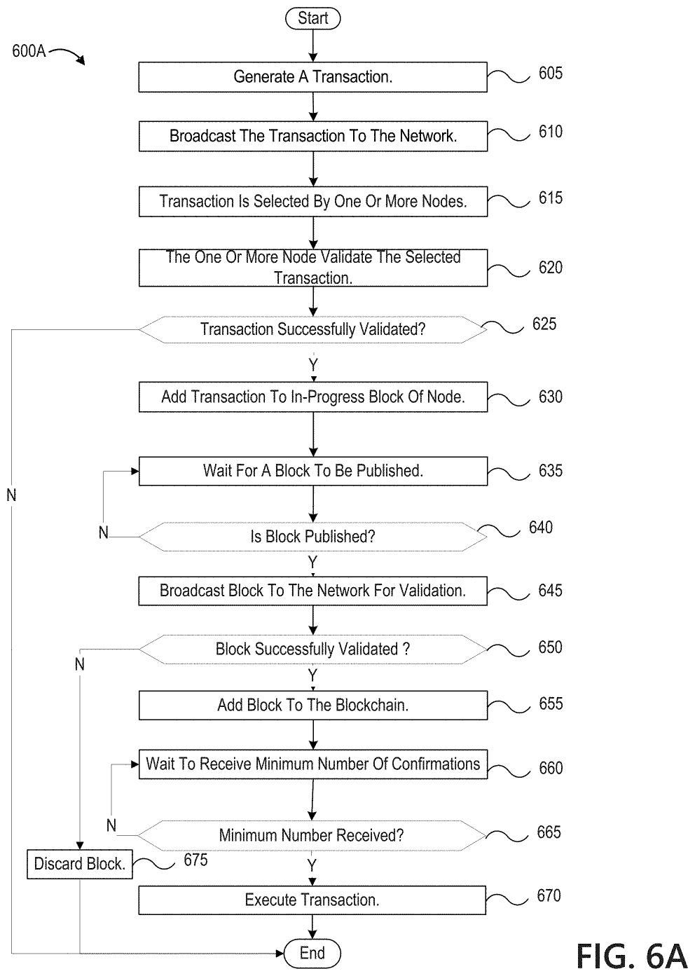

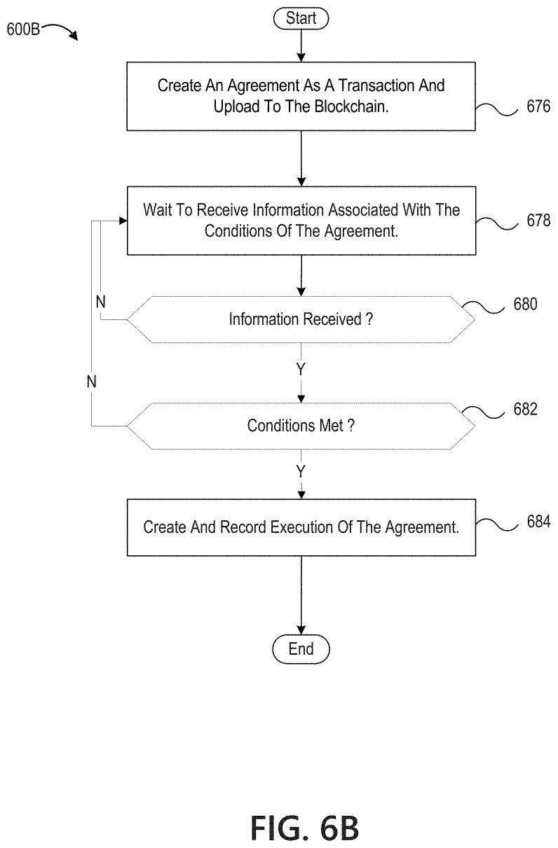

FIG. 6A is a flow diagram showing steps of an example process 600 for performing a blockchain transaction between entities, such as the first user 115 of the first client device 110 and the second user 125 of the second client device 120 in FIG. 1. The steps of the process 600 may be performed by any of the computing devices shown in FIG. 1. Alternatively or additionally, some or all of the steps of the process 600 may be performed by one or more other computing devices. Steps of the process 600 may be modified, omitted, and/or performed in other orders, and/or other steps added.

At step 605, the wallet application may generate transaction data for transferring the 10 units of cryptocurrency from the first user 115 to the second user 125. The wallet application may generate a public key for the transaction using the private key of the first user 115. In order to indicate that the first user 115 is the originator of the transaction, a digital signature may also be generated for the transaction using the private key of the first user 115. As discussed with reference to FIG. 4, the transaction data may include information, such as a blockchain address 430 of the sender, the digital signature 455, transaction output information 460, and the public key 415 of the sender. The transaction data may be sent to the server 150 from the first client device 110.

The server 150 may receive the transaction data from the first client device 110. At step 610, the server 150 may broadcast the transaction to the blockchain network 145a. The transaction may be received by one or more nodes 205 of the blockchain network 145a. At step 615, upon receiving the transaction, a node 205 may choose to validate the transaction, for example, based on transaction fees associated with the transaction. If the transaction is not selected for validation by any of the nodes 205, then the transaction may be placed in a queue and wait to be selected by a node 205.

At step 620, each of the nodes 205 that selected the transaction may validate the transaction. Validating the transaction may include determining whether the transaction is legal or conforms to a pre-defined set of rules for that transaction, establishing user authenticity, and establishing transaction data integrity. At step 625, if the transaction is successfully validated by a node 205, the validated transaction is added to a block being constructed by that node 205. As discussed above, since different nodes 205 may choose to validate different transactions, different nodes 205 may build or assemble a block comprising different validated transactions. Thus, the transaction associated with the first user 115 transferring 10 units of cryptocurrency to the second user 125 may be included in some blocks and not others.

At step 635, the blockchain network 145a may wait for a block to be published. Validated transactions may be added to the block being assembled by a node 205 until it reaches a minimum size specified by the blockchain. If the blockchain network 145a utilizes a proof of work consensus model, then the nodes 205 may compete for the right to add their respective blocks to the blockchain by solving a complex mathematical puzzle. The node 205 that solves its puzzle first wins the right to publish its block. As compensation, the winning node may be awarded a transaction fee associated with the transaction (e.g., from the wallet of the first user 115). Alternatively, or in addition, the winning node may be awarded compensation as an amount of cryptocurrency added to an account associated with the winning node from the blockchain network (e.g., “new” units of cryptocurrency entering circulation). This latter method of compensation and releasing new units of cryptocurrency into circulation is sometimes referred to as “mining ” At step 640, if a block has not been published, then the process 600 returns to step 635 and waits for a block to be published. However, at step 640, if a block has been published, then the process 600 proceeds to step 645.

At step 645, the published block is broadcast to the blockchain network 145a for validation. At step 650, if the block is validated by a majority of the nodes 205, then at step 655, the validated block is added to the blockchain 220. However, at step 650, if the block is not validated by a majority of the nodes 205, then the process 600 proceeds to step 675. At step 675, the block is discarded and the transactions in the discarded block are returned back to the queue. The transactions in the queue may be selected by one or more nodes 205 for the next block. The node 205 that built the discarded block may build a new next block.

At step 660, if the transaction was added to the blockchain 220, the server 150 may wait to receive a minimum number of blockchain confirmations for the transaction. At step 665, if the minimum number of confirmations for the transaction have not been received, then the process may return to step 660. However, if at step 665, the minimum number of confirmations have been received, then the process proceeds to step 670. At step 670, the transaction may be executed and assets from the first user 115 may be transferred to the second user 125. For example, the 10 units of cryptocurrency owned by the first user 115 may be transferred from a financial account of the first user 115 to a financial account of the second user 125 after the transaction receives at least three confirmations.

Smart Contracts

A smart contract as discussed herein is an agreement that is stored in a blockchain and automatically executed when the agreement's predetermined terms and conditions are met. The terms and conditions of the agreement may be visible to other users of the blockchain. When the pre-defined rules are satisfied, then the relevant code is automatically executed. The agreement may be written as a script using a programming language such as Java, C++, JavaScript, VBScript, PHP, Perl, Python, Ruby, ASP, Tcl, etc. The script may be uploaded to the blockchain as a transaction on the blockchain.

As an example, the first user 115 (also referred to as tenant 110) may rent an apartment from the second user 125 (also referred to as landlord 115). A smart contract may be utilized between the tenant 110 and the landlord 115 for payment of the rent. The smart contract may indicate that the tenant 110 agrees to pay next month's rent of $1000 by the 28^{th} of the current month. The agreement may also indicate that if the tenant 110 pays the rent, then the landlord 115 provides the tenant 110 with an electronic receipt and a digital entry key to the apartment. The agreement may also indicate that if the tenant 110 pays the rent by the 28^{th} of the current month, then on the last day of the current month, both the entry key and the rent are released respectively to the tenant 110 and the landlord 115.

FIG. 6B is a flow diagram showing steps of an example process 600B for performing a smart contract transaction between entities, such as the tenant 110 and the landlord 115. The steps of the process 600B may be performed by any of the computing devices shown in FIG. 1. Alternatively or additionally, some or all of the steps of the process 600B may be performed by one or more other computing devices. Steps of the process 600B may be modified, omitted, and/or performed in other orders, and/or other steps added.

At step 676, the agreement or smart contract between the tenant 110 and the landlord 115 may be created and then submitted to the blockchain network 145a as a transaction. The transaction may be added to a block that is mined by the nodes 205 of the blockchain network 145a, the block comprising the transaction may be validated by the blockchain network 145a and then recorded in the blockchain 220 (as shown in steps 610-655 in FIG. 6A). The agreement associated with the transaction may be given a unique address for identification.

At step 678, the process 600B waits to receive information regarding the conditions relevant for the agreement. For example, the process 600B may wait to receive notification that $1000 was sent from a blockchain address associated with the tenant 110 and was received at a blockchain address associated with the landlord 115 by the 28^{th} of the current month. At step 680, if such a notification is not received, then the process 600B returns to step 678. However, if at step 680, a notification is received, then the process 600B proceeds to step 682.

At step 682, based on determining that the received notification satisfies the conditions needed to trigger execution of the various terms of the smart contract, the process 600B proceeds to step 684. However, at step 682, if it is determined that the received notification does not satisfy the conditions needed to trigger execution of the smart contract, then the process 600B returns to step 678. At step 683, the process 600B creates a transaction associated with execution of the smart contract. For example, the transaction may include information of the payment received, the date the payment was received, an identification of the tenant 110 and an identification of the landlord 115. The transaction may be broadcast to the blockchain network 145a and recorded in the blockchain 220 (as shown in steps 610-655 of the process 600 of FIG. 6A). If the transaction is successfully recorded in the blockchain 220, the transaction may be executed. For example, if the payment was received on the 28^{th}, then an electronic receipt may be generated and sent to the tenant 110. However, on the last day of the current month, both the digital entry key and the rent are released respectively to the tenant 110 and the landlord 115.

Smart contracts may execute based on data received from entities that are not on the blockchain or off-chain resources. For example, a smart contract may be programmed to execute if a temperature reading from a smart sensor or IoT sensor falls below 10 degrees. Smart contracts are unable to pull data from off-chain resources. Instead, such data needs to be pushed to the smart contract. Additionally, even slight variations in data may be problematic since the smart contract is replicated across multiple nodes of the network. For example, a first node may receive a temperature reading of 9.8 degrees and a second node may receive a temperature reading of 10 degrees. Since validation of a transaction is based on consensus across nodes, even small variations in the received data may result in a condition of the smart contract to be evaluated as being not satisfied. Third party services may be utilized to retrieve off-chain resource information and push this to the blockchain. These third-party services may be referred to as oracles. Oracles may be software applications, such as a big data application, or hardware, such as an IoT or smart device. For example, an oracle service may evaluate received temperature readings beforehand to determine if the readings are below 10 degrees and then push this information to the smart contract. However, utilizing oracles may introduce another possible point of failure into the overall process. Oracles may experience errors, push incorrect information, or may even go out of business.

Since blockchains are immutable, amending or updating a smart contract that resides in a blockchain may be challenging and thus, more expensive and/or more restrictive than with text-based contracts.

Internet of Things (IoT)

An IoT network may include devices and sensors that collect data and relay the data to each other via a gateway. The gateway may translate between the different protocols of the devices and sensors as well as manage and process the data. IoT devices may, for example, collect information from their environments such as motions, gestures, sounds, voices, biometric data, temperature, air quality, moisture, and light. The collected information sent over the Internet for further processing. Typically, IoT devices use a low power network, Bluetooth, Wi-Fi, or satellite to connect to the Internet or “the cloud”. Some IoT related issues that blockchain may be able to detect include a lack of compliance in the manufacturing stage of an IoT device. For example, a blockchain may track whether an IoT device was adequately tested.

As discussed above, information from off-chain resources, including IoT devices, may be pushed to smart contracts via third party entities known as oracles. As an example, a smart refrigerator may monitor the use of an item stored in the refrigerator, such as milk. Various sensors within the refrigerator may be utilized for periodically determining an amount of milk stored in the refrigerator. A smart contract stored in a blockchain may indicate that if the weight of the stored milk falls below 10 ounces, then a new carton of milk is automatically purchased and delivered. The refrigerator sensors may periodically send their readings to a third-party service or oracle. The oracle may evaluate the sensor readings to determine whether the conditions for purchasing a new carton of milk have been met. Upon determining that the weight of the stored milk is below 10 ounces, the oracle may push information to the smart contract indicating that the condition for executing the smart contract has been met. The smart contract may be executed, and a new carton of milk may be automatically purchased. Both the execution of the smart contract and the purchase of the new carton may be recorded in the blockchain. In some cases, the condition may be an occurrence of an event, such as a need or anticipated need, or convenience factors, such as a delivery day, cost, promotions, or incentives.

Some issues related to the integration of blockchain into IoT include speed of transactions and computational complexity. The speed at which transactions are executed on the blockchain may be important when IoT networks with hundreds or thousands of connected devices are all functioning and transacting simultaneously. IoT devices are generally designed for connectivity rather than computation and therefore, may not have the processing power to support a blockchain consensus algorithm, such as proof of work. IoT devices also tend to be vulnerable to hacking via the Internet and/or physical tampering. For example, IoT devices may be more vulnerable to DDoS and malware attacks. Hackers may target a specific network and begin spamming the network with traffic within a short amount of time. Because of the increased surge in traffic, the bandwidth may be quickly overloaded, and the entire system may crash.

Tokens

A token may refer to an entry in the blockchain that belongs to a blockchain address. The entry may comprise information indicating ownership of an asset. The token may represent money, a contract, property, records, access rights, status, supply, demand, alarm, trigger, reputation, a ticket, or any other asset that may be represented in digital form. For example, a token may refer to an entry related to cryptocurrency that is used for a specific purpose or may represent ownership of a real-world asset, such as Fiat currency or real-estate. Token contracts refer to cryptographic tokens that represent a set of rules that are encoded in a smart contract. The person that owns the private key corresponding to the blockchain address may access the token(s) at the address. Thus, the blockchain address may represent an identity of the person that owns the token(s). Only the owner of the blockchain address may send the token to another person. The tokens may be accessible to the owner via the owner's wallet. The owner of a token may send or transfer the token to a user via a blockchain transaction. For example, the owner may sign the transaction corresponding to the transfer of the token with the private key. When the token is received by the user, the token may be recorded in the blockchain at the blockchain address of the user.

Different token standards may be used to define standard interfaces for different types of tokens on a decentralized blockchain. For example, tokens on the Ethereum blockchain may be implemented according to the ERC-20 standard for fungible tokens, the ERC-721 standard for non-fungible tokens, the ERC-994 standard, the ERC-998 standard, the ERC-1155 standard, and/or any other token standard configured for the Ethereum blockchain network or other blockchain network that includes a virtual machine for executing contract bytecode on its blockchain, as would be apparent to one of skill in the art in possession of the present disclosure. As would be apparent to one of skill in the art in possession of the present disclosure, a fungible token is a token that is indistinguishable from another token of the same type while a non-fungible token (NFT) is a unique token that can be distinguished from another token. A token that implements the ERC-994 standard and the ERC-994 standard may be considered non-fungible and may be hierarchical with other tokens that implement the ERC-994 standard. In other words, the tokens may form a tree-like structure of parent/child NFTs. In yet other examples, tokens that implement the ERC-1155 standard may be minted from a single smart contract, rather than a smart contract for each token as is required in many of the other standards. As such, a smart contract that implements the ERC-1155 standard may be used to generate both non-fungible and fungible tokens.

NFT Marketplace Transactions

FIG. 7 is a flow diagram of a process 700 for facilitating a transaction involving a purchase of an NFT via an NFT marketplace, according to an embodiment of the present disclosure. For purposes of discussion and explanation, process 700 will be described using system 100 of FIG. 1, as described above. Process 700 may be performed by, for example, server 150 of system 100, as described above. However, process 700 is not intended to be limited thereto. Process 700 and the operations described with respect to FIG. 7 may be performed by any suitable computer system or combination of computer systems, including those described in various embodiments of the present disclosure. The NFT in this example may represent any unique piece of digital data that can be tracked using a decentralized blockchain ledger, as described above. Such digital data may include, for example, any of various digital assets or tokenized versions of non-digital assets. Examples of such assets include, but are not limited to, digital images and videos, music, collectibles, and other digital art along with deeds to personal property, event tickets, legal documents, and other real-world items.

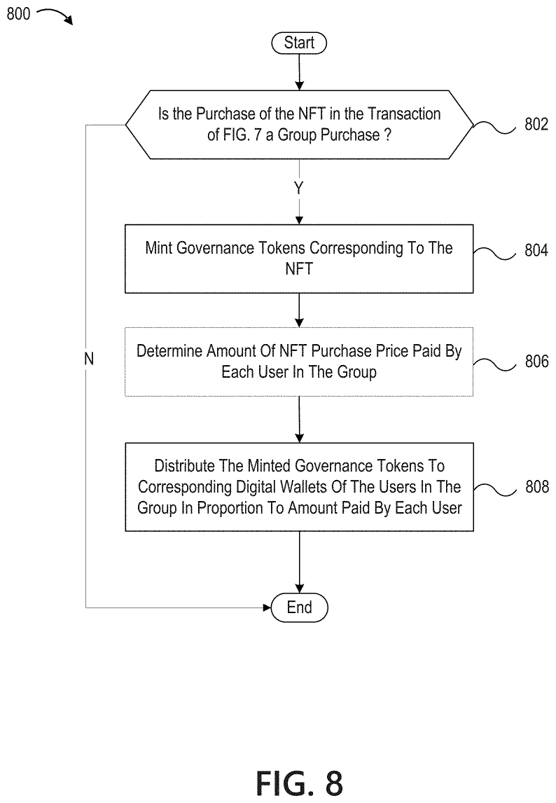

As shown in FIG. 7, process 700 begins in block 702, which includes providing a plurality of digital wallets associated with a service provider with access to an NFT marketplace, e.g., NFT marketplace 165 of FIG. 1, as described above. The plurality of digital wallets may correspond to, for example, different users of the service provider. The NFT marketplace in this example may correspond to a decentralized blockchain associated with an entity that is different from the service provider. It should be appreciated that the decentralized blockchain may support any of various token standards for managing the creation and transfer of NFTs, e.g., as a result of transactions involving the purchase or sale of the NFTs via the NFT marketplace. The plurality of digital wallets may be configured to hold NFTs and other types of tokens, e.g., fungible cryptocurrency tokens associated with the decentralized blockchain of the NFT marketplace. Thus, it should also be appreciated that these digital wallets may support any of various types of tokens and token standards as desired for a particular implementation. In some implementations, the types of tokens may include governance tokens representing fractional shares of a single NFT, which may be distributed to a group of users, as will be described in further detail below with respect to FIG. 8.

In one or more embodiments, each user of the service provider may be associated with a unique identifier, e.g., as assigned to the user during an initial registration process for a user account with the service provider. The identifier associated with each user may also be used to manage a corresponding digital wallet for that user. In some implementations, the plurality of digital wallets may be maintained as part of a single omnibus digital wallet associated with the service provider and shared with registered users of the service provider, e.g., as part of a digital wallet application or service provided by the service provider. Such a wallet application may enable each user to request transactions involving the purchase or sale of an NFT via the NFT marketplace. In some implementations, the wallet application may be executable at client devices of the respective users of the service provider, e.g., client devices 110 and 120 of respective users 115 and 125 of FIG. 1, as described above.

Accordingly, process 700 may proceed to block 704, which includes receiving, from a first user of the service provider, a request to perform a transaction involving a purchase, via the NFT marketplace, of an NFT associated with a specified source address. The first user in this example may be associated with a first identifier and a first digital wallet of the plurality of digital wallets associated with the service provider and provided in block 702. The specified source address associated with the NFT may be used to identify the current owner of the NFT.

Block 706 of process 700 includes determining whether the specified source address of the NFT (e.g., the blockchain or wallet address that currently holds the NFT) corresponds to the service provider. If it is determined in block 706 that the specified source address does not correspond to the service provider, this indicates that the current owner of the NFT is a third-party user who is not a user of the service provider. In this case, it may be assumed that the specified source address corresponds to a decentralized wallet of the third-party user and process 700 may proceed to block 714. In block 714, the transaction is handled as an on-chain transaction and broadcasted to the appropriate blockchain network, e.g., blockchain network 145a of FIG. 1, as described above, to initiate a transfer of the NFT from the decentralized wallet of the third-party user to the first digital wallet of the first user. The blockchain network in this example may include a network of nodes associated with the decentralized blockchain that corresponds to the NFT marketplace.

If, however, it is determined in block 706 that the specified source address corresponds to the service provider, process 700 may proceed to block 708. Block 708 includes determining that the NFT is owned by a second user of the service provider who may be associated with a second identifier. The second identifier in this example may be used in block 710 to identify, amongst the plurality of digital wallets associated with the service provider, a second digital wallet that corresponds to the second user. Process 700 may then proceed to block 712, which includes changing or updating an identifier associated with the NFT from the second identifier associated with the second user (or the second digital wallet of the second user) to the first identifier associated with the first user (or the first digital wallet of the first user). Thus, the transaction in this instance may be handled as an off-chain transaction without involving the blockchain network or having to pay the gas fees typically associated with on-chain transactions. In some embodiments, the purchase involved in the transaction may be a group purchase by multiple users of the service provider, as will be described in further detail with respect to FIG. 8.

FIG. 8 is a flow diagram of a process 800 for facilitating a group purchase of the NFT involved in the transaction of FIG. 7, according to an embodiment of the present disclosure. Like process 700 of FIG. 7, process 800 will be described using system 100 of FIG. 1 for purposes of discussion and explanation, but process 800 is not intended to be limited thereto. For example, like process 700, process 800 may be performed by server 150 of system 100, as described above. Referring to process 700 of FIG. 7, as described above, the transaction requested by the first user at block 704 may, under certain circumstances, involve a group purchase initiated by the first user on behalf of a group that includes the first user and other users of the service provider.

Thus, as shown in FIG. 8, process 800 may begin in block 802, which includes determining whether the purchase of the NFT in the requested transaction is a group purchase. If it is determined in block 802 that the transaction is not a group purchase, then the transaction is handled according to process 700, as described above with respect to FIG. 7, and process 800 ends. In some implementations, the determination in block 802 of whether the purchase is a group purchase may be performed as part of block 712 of process 700, e.g., as an initial step prior to updating the identifier associated with the NFT.

On the other hand, if it is determined in block 802 that the purchase of the NFT in the transaction is a group purchase, process 800 proceeds to block 804, which includes minting governance tokens corresponding to the NFT. The governance tokens in this example may represent fractional shares of ownership in the NFT that was purchased via the NFT marketplace. The governance tokens may be implemented as, for example, fungible tokens on the decentralized blockchain associated with the NFT marketplace using an appropriate token standard, e.g., the ERC-20 standard for fungible tokens on the Ethereum blockchain, as described above. The NFT in this example may be implemented using a different token standard, e.g., the ERC-721 standard for non-fungible tokens on the Ethereum blockchain.

In one or more embodiments, the minted governance tokens may be distributed to corresponding digital wallets of the users in the group, including the first user, based on the amount paid or contributed by each user towards the purchase price of the NFT. Accordingly, process 800 may proceed to block 806, which includes determining an amount of a purchase price of the NFT that was paid by each user in the group. In block 808, the minted governance tokens are distributed to the corresponding digital wallets of the users in the group in proportion to the amount paid by each user in the group for the purchase of the NFT. While not shown in FIG. 8, it should be appreciated that process 800 (e.g., in block 804, 806, or 808) may also include determining which users are in the group and identifying the corresponding digital wallet of each user determined to be in the group. Also, while not shown in FIG. 8, process 800 (e.g., at block 808) in some embodiments may include associating the NFT with a list of identifiers corresponding to the users in the group. Furthermore, in some embodiments, the group of users may include only users of the service provider, users of the service provider as well as users of a second service provider (such as an associated service provider), decentralized users, or a mix of any of the foregoing.

In some embodiments, the distributed governance tokens may be freely transferable to other users of the service provider, including, for example, other users in the group who may later wish to own a great share of the NFT. For example, the first user in the above example may initiate a request to transfer a corresponding portion of the distributed governance tokens from the first user's digital wallet (e.g., a first digital wallet of the plurality of digital wallets provided in block 702 of FIG. 7, as described above) to a third digital wallet of the plurality of digital wallets corresponding to a third user of the service provider. Once the governance tokens are transferred from the first digital wallet of the first user to the third digital wallet of the third user, the list of identifiers associated with the NFT may be updated to include a third identifier associated with the third user in place of the first identifier associated with the first user. By providing a mechanism for group purchases and fractional ownership, governance tokens enable more users of the service provider to engage in NFT marketplace transactions and own a part of an NFT without having to pay the full purchase price. The fungible and transferable nature of these tokens also enable the NFT to be liquid.

In some embodiments, a decentralized autonomous organization (DAO) associated with the service provider may be used to promote NFT liquidity through a dedicated platform for managing the ownership and exchange of fractional shares in an NFT, as represented by its corresponding governance tokens. Such a platform may be implemented using, for example, a private decentralized blockchain network (e.g., blockchain network 145c of FIG. 1, as described above) associated with the service provider. The private decentralized blockchain of the platform may also be used to mint the governance tokens corresponding to the NFT in this example.

In some embodiments, the NFT may represent an income-earning digital asset owned by a group of users associated with the service provider, e.g., based on the list of identifiers associated with the NFT, as described above. The income associated with the asset may include, for example, royalties that are earned from the sale or resale of the NFT or fractional share thereof. For example, digital wallets of the plurality of digital wallets associated with the service provider (e.g., as provided in block 702 of FIG. 7, as described above), which correspond to the users in the group may be identified. A total income earned by the digital asset over time, e.g., over any predetermined or user-specified time period, may be determined and then distributed to the identified digital wallets in proportion to the governance tokens in each of the identified digital wallets.

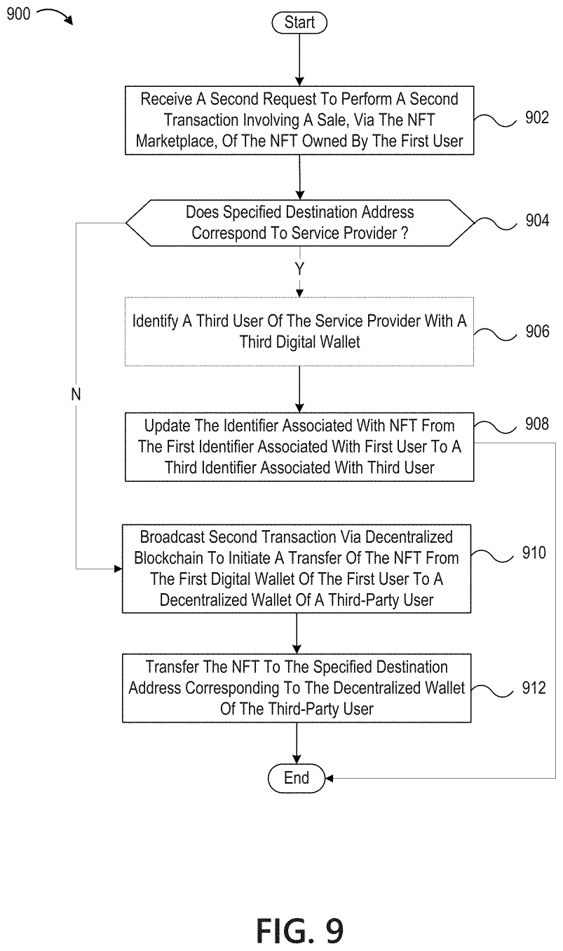

As the users in the group are the owners of the income-earning digital asset represented by the NFT in this example, the list of identifiers associated with the NFT may represent a list of the current owners of the income-earning digital asset. Such a list may be useful for purposes of tracking any ownership changes that may occur over time to ensure that the income earned by the digital asset gets distributed to the rightful owners of the asset at the time of distribution. In some cases, a notification of such an ownership change may be received prior to distributing the total income earned by the digital asset. The notification may indicate, for example, that a portion of the governance tokens in the first digital wallet of the first user (e.g., as distributed in block 808 of FIG. 8, described above) have been transferred to a third digital wallet of a third user of the service provider. In this case, the list of identifiers corresponding to the owners of the income-earning digital asset may be updated to include a third identifier associated with the third user, based on the portion of the governance tokens transferred to the third digital wallet. This ensures that the digital wallets that are identified prior to the distribution of the total income include the third digital wallet of the third user. In some embodiments, the total income may be distributed to the identified digital wallets as fungible cryptocurrency tokens associated with the decentralized blockchain that corresponds to the NFT marketplace. The notification in the above example may be triggered by a sale of the NFT via the NFT marketplace, as will be described below with respect to FIG. 9.

FIG. 9 is a flow diagram of a process 900 for facilitating a transaction involving a sale of the NFT by a user of the digital wallet service provider via the NFT marketplace of FIG. 7, according to an embodiment of the present disclosure. Like process 700 of FIG. 7, process 900 will be described using system 100 of FIG. 1 for purposes of discussion and explanation. For example, like process 700, process 900 may be performed by server 150 of system 100, as described above. However, process 900 is not intended to be limited thereto. It may be assumed that the user of the service provider in this example is the first user that requested (at block 704 of FIG. 7, as described above) the initial transaction involving the purchase of the NFT via the NFT marketplace.

As shown in FIG. 9, process 900 begins in block 902, which includes receiving a second request to perform a second transaction involving a sale, via the NFT marketplace, of the NFT now owned by the first user to a specified destination address, e.g., an address corresponding to a buyer or digital wallet thereof. Process 900 then proceeds to block 904, which includes determining whether the specified destination address corresponds to the service provider.

If the specified destination address corresponds to the service provider, process 900 proceeds to block 906, which includes identifying a third user of the service provider (different from the first and second users discussed above with respect to FIG. 7). Process 900 then proceeds to block 908, which includes updating the identifier associated with the NFT from the first identifier associated with the first user to the third identifier associated with the third user. Process 900 concludes thereafter.

On the other hand, if it is determined in block 904 that the specified destination address corresponds to the decentralized wallet of a third-party user (or buyer) who is not associated with the service provider, process 900 proceeds to block 910. Block 910 includes broadcasting the second transaction to the appropriate blockchain network to initiate a transfer of the NFT to the specified destination address corresponding to the decentralized wallet of the third-party user. The blockchain network in this example may be a network of nodes associated with the decentralized blockchain that corresponds to the NFT marketplace. Process 900 then proceeds to block 912, in which the NFT is transferred to the specified destination address corresponding to the decentralized wallet of the third-party user.

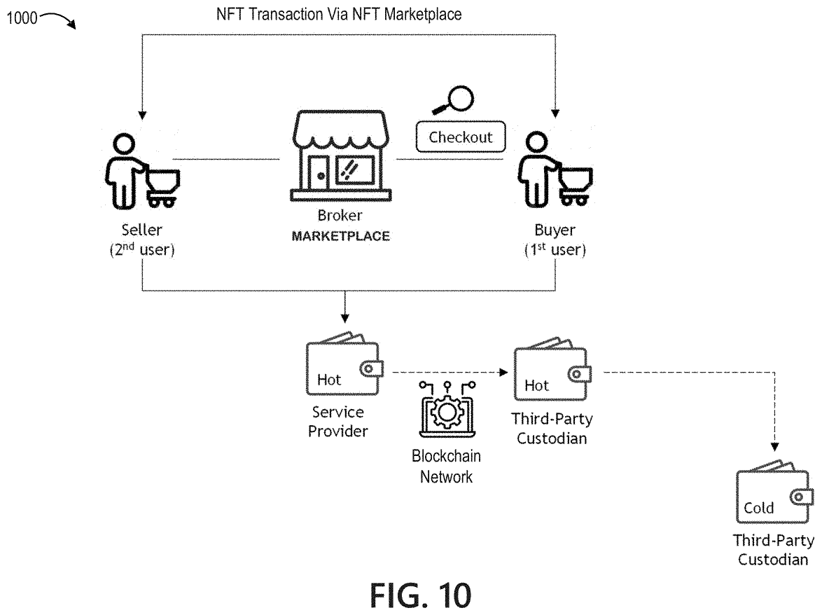

FIGS. 10-13 are diagrams illustrating examples of different workflows in which processes 700, 800, and 900 of FIGS. 7, 8, and 9, respectively, as described above, may be applied to facilitate transactions involving the purchase and transfer of an NFT between a buyer and a seller. The buyer or the seller (or both) in each of these workflows may be a user of a digital wallet associated with a service provider. As described above, the digital wallet may be one of a plurality of digital wallets associated with the service provider, where each digital wallet may correspond to a different user of the service provider. Also, as described above with respect to block 702 of FIG. 7, the plurality of wallets may be provided access to an NFT marketplace associated with an entity that is different from the service provider. Further, the plurality of wallets in some implementations may be maintained as part of a single omnibus wallet associated with the service provider. While the workflow shown in each of FIGS. 10-13 involves an indirect transaction between a buyer and a seller via such an NFT marketplace, which is associated with a third-party broker, it should be appreciated that embodiments of the present disclosure are not limited thereto. These same workflows may also apply to direct transactions in which buyers and sellers may directly purchase and transfer NFTs from one another without involving a third-party broker or going through an NFT marketplace.

FIG. 10 illustrates an example of a workflow 1000 for a transaction involving the purchase and transfer of an NFT between a buyer and a seller who are different users of the service provider. For example, referring to process 700 of FIG. 7, as described above, the buyer may be a first user of the service provider who requested the transaction in block 704 and the seller may be a second user of the service provider who is the owner of the NFT, as determined in block 708. In some embodiments, the request for the transaction may be received by the service provider via an application programming interface (API) connection of the service provider established between a device of the first user (e.g., client device 110 of user 115 in system 100 of FIG. 1, as described above) and the NFT marketplace (e.g., NFT marketplace 165 of FIG. 1). As described above, the NFT marketplace may be a decentralized application or blockchain-integrated e-commerce website hosted by a third-party broker that enables sellers to list and promote their NFTs and buyers to initiate transactions involving the purchase and transfer of NFTs via a corresponding decentralized blockchain. The buyer and seller may each access the NFT marketplace via, for example, a web browser or other standalone application executable at each user's device, as described above.

In some implementations, the buyer and seller may be able to utilize the API connection of the service provider, as described above, to buy and sell NFTs on the NFT marketplace platform without having to have a decentralized wallet to connect to the marketplace or preloaded cryptocurrency in the wallet to pay for any transaction-related gas fees. The API connection may be made available to each user via, for example, a website of the service provider (e.g., hosted by server 150 of FIG. 1, as described above) loaded within a web browser executable at each user's device. Additionally, the service provider may provide a browser extension that provides the functionality for establishing the API connection when the user visits third-party broker's website for the NFT marketplace directly via the web browser at the user's device. Alternatively, such functionality may be integrated or embedded within the third-party broker's website. For example, the NFT marketplace may enable a buyer who is also a user of the service provider to request transactions involving the purchase of an NFT via a checkout interface that integrates the service provider's API connection functionality for facilitating and processing the requested transactions. In one or more embodiments, the transaction processing performed by the service provider may include validation of each transaction and the NFT provisioning status of each user's digital wallet. Such processing may also include any of various risk and compliance checks for the transaction as desired for a particular implementation.

As both the buyer and seller in the example shown in FIG. 10 are users of the service provider, the transaction may be handled as an off-chain transaction by updating an identifier associated with the NFT from the identifier of the seller (second user) to the identifier of the buyer (first user), as in block 712 of process 700 described above. While the buyer or first user in this example may be associated with a first digital wallet and the seller or second user may be associated with a second digital wallet, both digital wallets may be maintained as part of single omnibus wallet associated with the service provider. Thus, no actual transfer of the NFT takes place. Therefore, no transfer is registered on the blockchain and there is no need to broadcast the transaction to the blockchain network or pay the gas fees associated with such an on-chain transaction. Furthermore, the transaction may be processed using any form of currency as desired for a particular implementation rather than being limited to the cryptocurrency associated with the decentralized blockchain.

The omnibus wallet associated with the service provider in this example may be a hot wallet. In some embodiments, an additional (on-chain) transaction may be initiated by the service provider to transfer the NFT from the hot wallet (or first digital wallet associated with the first user) to a corresponding cold wallet maintained by a trusted third-party custodian associated with the service provider. As shown in FIG. 10, the NFT may pass through an intermediate hot wallet associated with the third-party custodian as part of this transfer. Unlike the off-chain transaction between different users of the same service provider, the additional transaction is an on-chain transaction broadcasted to the appropriate blockchain network (e.g., blockchain network 145b or 145c of FIG. 1, as described above) and therefore, will incur the associated gas fees. As described above, the blockchain network in this example may include a network of nodes associated with the decentralized blockchain that corresponds to the NFT marketplace.

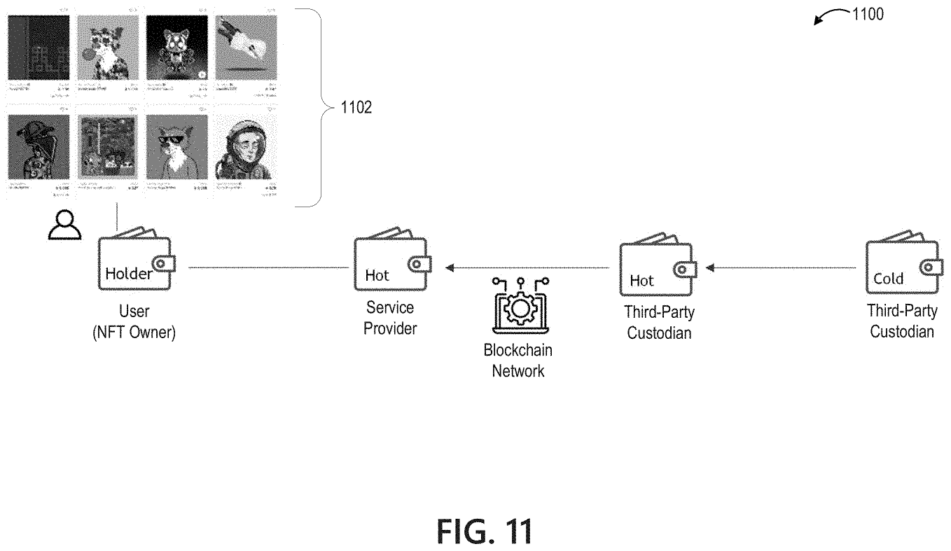

FIG. 11 illustrates an example of a workflow 1100 for holding and showcasing NFTs purchased by a user of the service provider of FIG. 10. Workflow 1100 may be performed based on input received from the buyer (first user of the service provider) via, for example, a graphical user interface (GUI) displayed at the user's device (e.g., client device 110 of FIG. 1, as described above). The GUI may be used to provide a plurality of options selectable by the user for viewing or showcasing an image associated with the NFT purchased via the NFT marketplace. As shown in FIG. 11, the image may be displayed in a gallery view 1102 along with images associated with other NFTs in the user's wallet. The options presented to the user via the GUI may also include options for sharing a selected NFT image (or a collection of images) for view by other users of the NFT marketplace. For example, when the user selects the option for gallery view 1102, the service provider may coordinate with the third-party custodian via the blockchain network to retrieve a selected NFT and its associated properties. Such properties may include, for example and without limitation, a source address corresponding to the user's digital wallet, a transaction hash for the NFT, an identifier associated with the NFT (e.g., an assigned identifier of the user and current owner), an image or media file type, and any other metadata that may be associated with the NFT.

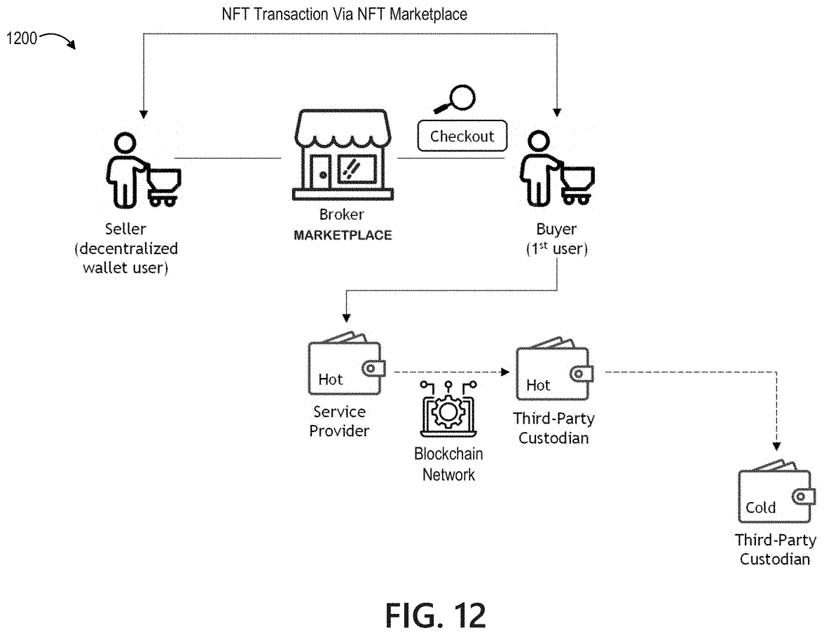

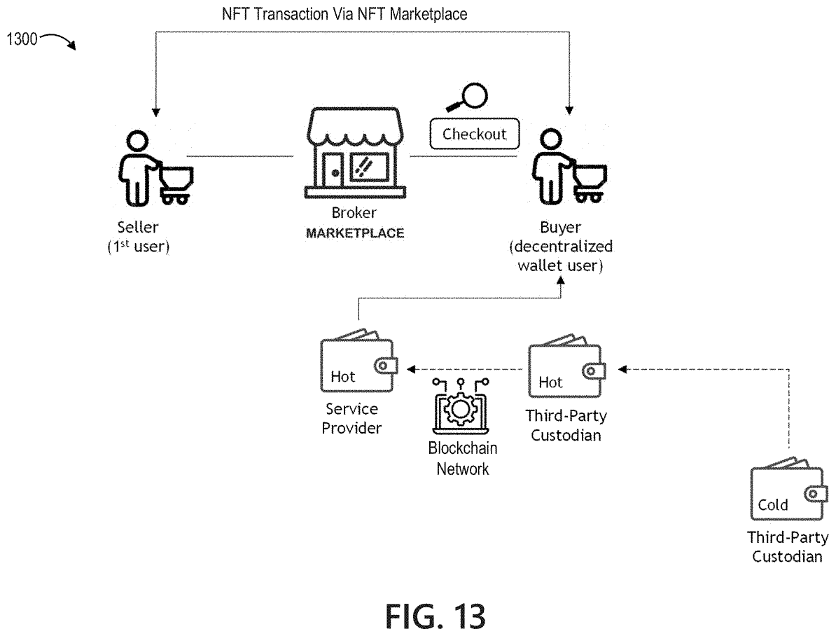

FIG. 12 illustrates another example of a workflow 1200 for an NFT marketplace transaction involving the purchase and transfer of an NFT between a buyer who is a user of the service provider and a seller who is a third-party decentralized wallet user. FIG. 13 illustrates yet another example of a workflow 1300 for an NFT marketplace transaction involving the sale and transfer of an NFT between a seller who is a user of the service provider of FIG. 10 and a buyer who is a third-party decentralized wallet user. The buyer in workflow 1200 of FIG. 12 and the seller in workflow 1300 of FIG. 13 may be, for example, the same first user of the service provider as in workflow 1000 of FIG. 10 (e.g., user 115 of client device 110 of FIG. 1), as described above.

Unlike the off-chain transaction between the first user and a second user of the service provider in workflow 1000 of FIG. 10, as described above, the transaction as shown in each of FIGS. 12 and 13 is an on-chain transaction that involves a third-party decentralized wallet user (e.g., user 135 of client device 130 of FIG. 1, as described above). Thus, the transaction in each of these examples is broadcasted to the appropriate blockchain network (e.g., blockchain network 145b or 145c of FIG. 1, as described above) and therefore, will incur the associated gas fees. For example, as shown in FIG. 12, workflow 1200 may involve broadcasting, to the appropriate blockchain network, a transaction involving the purchase and transfer of an NFT owned by the third-party user from a specified source address corresponding to the decentralized wallet of the third-party user to the digital wallet corresponding to the first user (buyer in this transaction).

As shown in FIG. 13, workflow 1300 may involve broadcasting a transaction involving the purchase of an NFT owned by the first user (seller in this transaction) to the appropriate blockchain network to initiate a transfer of the NFT to a specified destination address corresponding to the decentralized wallet of the third-party user. As the NFT may be held in a cold wallet of a third-party custodian, one or more additional transactions may need be broadcasted to the blockchain network (and additional gas fees paid) to retrieve or transfer the NFT from the cold wallet of the third-party custodian to the hot wallet of the service provider being it can be transferred to the specified destination address corresponding to the decentralized wallet of the third-party user.

Client-Server System

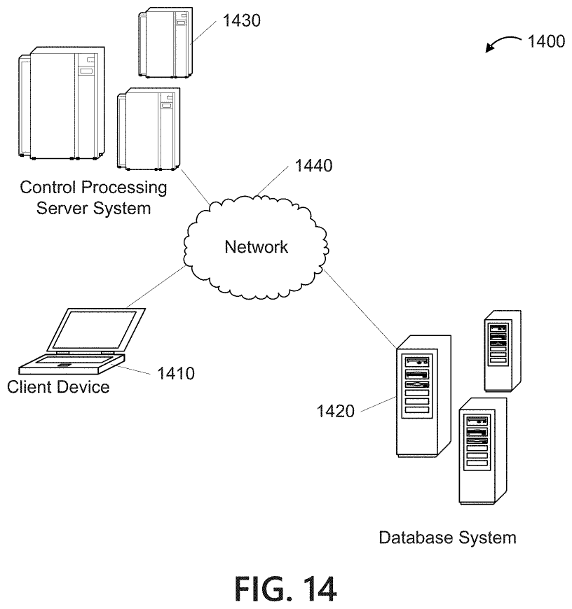

FIG. 14 shows a client-server system 1400. The system 1400 may include at least one client device 1410, at least one database system 1420, and/or at least one server system 1430 in communication via a network 1440. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. Any of the devices and systems described herein may be implemented, in whole or in part, using one or more computing systems described with respect to FIG. 14.

Client device 1410 may access server applications and/or resources using one or more client applications (not shown) as described herein. Client device 1410 may be a mobile device, such as a laptop, smart phone, mobile phones, or tablet, or computing devices, such as a desktop computer or a server, wearables, embedded devices. Alternatively, client device 1410 may include other types of devices, such as game consoles, camera/video recorders, video players (e.g., incorporating DVD, Blu-ray, Red Laser, Optical, and/or streaming technologies), smart TVs, and other network-connected appliances, as applicable.

Database system 1420 may be configured to maintain, store, retrieve, and update information for server system 1430. Further, database system may provide server system 1430 with information periodically or upon request. In this regard, database system 1420 may be a distributed database capable of storing, maintaining, and updating large volumes of data across clusters of nodes. Database system 1420 may provide a variety of databases including, but not limited to, relational databases, hierarchical databases, distributed databases, in-memory databases, flat file databases, XML databases, NoSQL databases, graph databases, and/or a combination thereof.

Server system 1430 may be configured with a server application (not shown) that is capable of interfacing with client application and database system 1420 as described herein. In this regard, server system 1430 may be a stand-alone server, a corporate server, or a server located in a server farm or cloud-computer environment. According to some examples, server system 1430 may be a virtual server hosted on hardware capable of supporting a plurality of virtual servers.

Network 1440 may include any type of network. For example, network 1440 may include a local area network (LAN), a wide area network (WAN), a wireless telecommunications network, and/or any other communication network or combination thereof. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies.

The data transferred to and from various computing devices in a system 1400 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in the system 1400. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls. Such specialized hardware may be installed and configured in the system 1400 in front of one or more computing devices such that any external devices may communicate directly with the specialized hardware.

Computing Device

Turning now to FIG. 15, a computing device 1500 that may be used with one or more of the computational systems is described. The computing device 1500 may include a processor 1503 for controlling overall operation of the computing device 1500 and its associated components, including RAM 1505, ROM 1507, input/output (I/O) device 1509, communication interface 1511, and/or memory 1515. A data bus may interconnect processor(s) 1503, RAM 1505, ROM 1507, memory 1515, I/O device 1509, and/or communication interface 1511. In some embodiments, computing device 1500 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

Input/output (I/O) device 1509 may include a microphone, keypad, touch screen, and/or stylus motion, gesture, through which a user of the computing device 1500 may provide input, and may also include one or more of a speaker for providing audio output and a video display device for providing textual, audiovisual, and/or graphical output. Software may be stored within memory 1515 to provide instructions to processor 1503 allowing computing device 1500 to perform various actions. For example, memory 1515 may store software used by the computing device 1500, such as an operating system 1517, application programs 1519, and/or an associated internal database 1521. The various hardware memory units in memory 1515 may include volatile and nonvolatile, removable and non-removable media implemented in any method or technology for storage of information such as computer-readable instructions, data structures, program modules, or other data. Memory 1515 may include one or more physical persistent memory devices and/or one or more non-persistent memory devices. Memory 1515 may include, but is not limited to, random access memory (RAM) 1505, read only memory (ROM) 1507, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 1503.

Communication interface 1511 may include one or more transceivers, digital signal processors, and/or additional circuitry and software for communicating via any network, wired or wireless, using any protocol as described herein.

Processor 1503 may include a single central processing unit (CPU), which may be a single-core or multi-core processor, or may include multiple CPUs. Processor(s) 1503 and associated components may allow the computing device 1500 to execute a series of computer-readable instructions to perform some or all of the processes described herein. Although not shown in FIG. 15, various elements within memory 1515 or other components in computing device 1500, may include one or more caches, for example, CPU caches used by the processor 1503, page caches used by the operating system 1517, disk caches of a hard drive, and/or database caches used to cache content from database 1521. For embodiments including a CPU cache, the CPU cache may be used by one or more processors 1503 to reduce memory latency and access time. A processor 1503 may retrieve data from or write data to the CPU cache rather than reading/writing to memory 1515, which may improve the speed of these operations. In some examples, a database cache may be created in which certain data from a database 1521 is cached in a separate smaller database in a memory separate from the database, such as in RAM 1505 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 1500 are described separately, functionality of the various components may be combined and/or performed by a single component and/or multiple computing devices in communication without departing from the invention.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A system comprising:
a non-transitory memory; and
one or more hardware processors coupled to the non-transitory memory and configured to read instructions from the non-transitory memory to cause the system to perform operations comprising:
providing a plurality of digital wallets associated with a service provider with access to a non-fungible token (NFT) marketplace, wherein the NFT marketplace corresponds to a decentralized blockchain associated with an entity that is different from the service provider;
receiving, from a first user of the service provider associated with a first identifier and a first digital wallet of the plurality of digital wallets, a request to perform a transaction involving a purchase, via the NFT marketplace, of an NFT associated with a specified source address;
determining that the specified source address corresponds to the service provider;
based on determining that the specified source address corresponds to the service provider:
determining that the NFT is owned by a second user of the service provider associated with a second identifier;
identifying a second digital wallet of the plurality of digital wallets that corresponds to the second user; and
updating an identifier associated with the NFT from the second identifier associated with the second user to the first identifier associated with the first user.

2. The system of claim 1, wherein the request for the transaction is received via an application programming interface (API) connection of the service provider established between a device of the first user and the NFT marketplace.

3. The system of claim 1, wherein the plurality of digital wallets are maintained as part of a single omnibus digital wallet associated with the service provider.

4. The system of claim 1, wherein the first digital wallet of the first user is a hot wallet associated with the service provider, and the operations further comprise:
broadcasting an additional transaction to a network of nodes associated with the decentralized blockchain for transferring the NFT from the hot wallet of the first user to a corresponding cold wallet maintained by a trusted third-party custodian associated with the service provider.

5. The system of claim 1, wherein the purchase is a group purchase initiated by the first user on behalf of a group that includes the first user and other users associated with the service provider, and wherein the operations further comprise:
minting governance tokens corresponding to the NFT;
determining an amount of a purchase price of the NFT that was paid by each user in the group; and
distributing, to corresponding digital wallets of the users in the group, the minted governance tokens in proportion to the amount paid by each user in the group for the purchase of the NFT.

6. The system of claim 5, wherein the operations further comprise:
associating the NFT with a list of identifiers corresponding to the users in the group;
receiving, from the first user, a second request to transfer a corresponding portion of the distributed governance tokens from the first digital wallet of the first user to a third digital wallet of the plurality of wallets that corresponds to a third user of the service provider;
transferring the corresponding portion of the governance tokens from the first digital wallet of the first user to the third digital wallet of the third user; and
updating the list of identifiers associated with the NFT to include a third identifier associated with the third user in place of the first identifier associated with the first user.

7. The system of claim 5, wherein the NFT represents an income-earning digital asset owned by the group, and the operations further comprise:
determining a total income earned by the digital asset over a time period;
identifying digital wallets of the plurality of digital wallets that correspond to the users in the group; and
distributing the total income to the identified digital wallets in proportion to the governance tokens in each of the identified digital wallets.

8. The system of claim 7, wherein the users in the group are owners of the income-earning digital asset, and the operations further comprise:
associating the NFT with a list of identifiers corresponding to the owners of the income-earning digital asset;
receiving, prior to distributing the total income earned by the digital asset, a notification that a portion of the governance tokens in the first digital wallet of the first user have been transferred to a third digital wallet of a third user of the service provider; and
updating the list of identifiers corresponding to the owners of the income-earning digital asset to include a third identifier associated with the third user, based on the portion of the governance tokens transferred to the third digital wallet,
wherein the identified digital wallets include the third digital wallet of the third user.

9. The system of claim 7, wherein the total income is distributed to the identified digital wallets as fungible cryptocurrency tokens associated with the decentralized blockchain.

10. The system of claim 1, wherein the operations further comprise:
receiving a second request to perform a second transaction involving a sale, via the NFT marketplace, of the NFT owned by the first user of service provider to a specified destination address;
determining that the specified destination address corresponds to a decentralized wallet of a third-party user of the NFT marketplace;
based on determining that the specified destination address corresponds to the decentralized wallet of the third-party user:
broadcasting the second transaction to a network of nodes associated with the decentralized blockchain to initiate a transfer of the NFT to the specified destination address corresponding to the decentralized wallet of the third-party user; and
transferring the NFT to the specified destination address corresponding to the decentralized wallet of the third-party user.

11. A method comprising:
providing a plurality of digital wallets associated with a service provider with access to a non-fungible token (NFT) marketplace, wherein the NFT marketplace corresponds to a decentralized blockchain associated with an entity that is different from the service provider;
receiving, from a first user of the service provider associated with a first identifier and a first digital wallet of the plurality of digital wallets, a request to perform a transaction involving a purchase, via the NFT marketplace, of an NFT associated with a specified source address;
responsive to determining that the specified source address corresponds to the service provider, identifying a second user of the service provider as having ownership of the NFT, wherein the second user is associated with a second identifier and a second digital wallet of the plurality of digital wallets; and
transferring the ownership of the NFT from the second user to the first user by updating an identifier associated with the NFT from the second identifier associated with the second user to the first identifier associated with the first user.

12. The method of claim 11, wherein the first and second digital wallets of the respective first and second users are parts of a single omnibus digital wallet associated with the service provider, and the transaction between the first and second users is processed as an off-chain transaction outside of the decentralized blockchain.

13. The method of claim 11, wherein the purchase is a group purchase initiated by the first user is on behalf of a group that includes the first user and other users associated with the service provider, and the method further comprises:
minting governance tokens corresponding to the NFT;
determining an amount of a purchase price of the NFT that was paid by each user in the group; and
distributing, to corresponding digital wallets of the users in the group, the minted governance tokens in proportion to the amount paid by each user in the group for the purchase of the NFT.

14. The method of claim 13, further comprising:
associating the NFT with a list of identifiers corresponding to the users in the group;
receiving, from the first user, a second request to transfer a corresponding portion of the distributed governance tokens from the first digital wallet of the first user to a third digital wallet of the plurality of wallets that corresponds to a third user of the service provider;
transferring the corresponding portion of the governance tokens from the first digital wallet of the first user to the third digital wallet of the third user; and
updating the list of identifiers associated with the NFT to include a third identifier associated with the third user in place of the first identifier associated with the first user.

15. The method of claim 13, wherein the NFT represents an income-earning digital asset owned by the group, and the method further comprises:
determining a total income earned by the digital asset over a time period;
identifying digital wallets of the plurality of digital wallets that correspond to the users in the group; and
distributing the total income to the identified digital wallets in proportion to the governance tokens in each of the identified digital wallets.

16. The method of claim 11, further comprising:
transferring, to a trusted third-party custodian associated with the service provider, the NFT for long-term storage in a cold wallet maintained by the trusted third-party custodian on behalf of the first user.

17. The method of claim 11, further comprising:
providing, via a graphical user interface (GUI) displayed at a device of the first user, a plurality of options for viewing an image associated with the NFT and sharing the image for view by other users of the NFT marketplace.

18. A non-transitory machine-readable medium having stored thereon machine-readable instructions executable to cause a machine to perform operations comprising:
providing a plurality of digital wallets associated with a service provider with access to a non-fungible token (NFT) marketplace, wherein the NFT marketplace corresponds to a decentralized blockchain associated with an entity that is different from the service provider;
receiving, from a first user of the service provider associated with a first identifier and a first digital wallet of the plurality of digital wallets, a request to perform a transaction involving a purchase, via the NFT marketplace, of an NFT associated with a specified source address;
determining that the specified source address corresponds to a second user of the service provider associated with a second identifier and a second digital wallet of the plurality of digital wallets; and
updating an identifier associated with the NFT from the second identifier associated with the second user to the first identifier associated with the first user.

19. The non-transitory machine-readable medium of claim 18, wherein the purchase is a group purchase initiated by the first user on behalf of a group of users that includes the first user and other users associated with the service provider, and the operations further comprise:
minting governance tokens corresponding to the NFT;
determining an amount of a purchase price of the NFT that was paid by each user in the group; and
distributing, to corresponding digital wallets of the users in the group, the minted governance tokens in proportion to the amount paid by each user in the group for the purchase of the NFT.

20. The non-transitory machine-readable medium of claim 18, wherein the operations further comprise:
receiving a second request to perform a second transaction involving a sale, via the NFT marketplace, of the NFT owned by the first user of service provider to a specified destination address;
responsive to determining that the specified destination address corresponds to a decentralized wallet of a third-party user of the NFT marketplace:
broadcasting the second transaction to a network of nodes associated with the decentralized blockchain to initiate a transfer of the NFT to the specified destination address corresponding to the decentralized wallet of the third-party user; and
transferring the NFT to the specified destination address corresponding to the decentralized wallet of the third-party user.
